(19) United States
(12) Patent Application Publication
(10) Pub. No.: US 2025/0317247 A1
(43) Pub. Date: Oct. 9, 2025

(54) SYNCHRONIZATION SIGNAL BLOCK TRANSMISSION FOR FLEXIBLE SPECTRUM INTEGRATION

(71) Applicant: QUALCOMM Incorporated, San Diego, CA (US)

(72) Inventors: Jing LEI, San Diego, CA (US); Kazuki TAKEDA, Minato-ku (JP); Yongle WU, San Diego, CA (US)

(21) Appl. No.: 18/628,199

(22) Filed: Apr. 5, 2024

(51) Int. Cl. H04L 5/00; H04B 1/7156; H04W 72/23

(52) U.S. Cl. CPC H04L 5/0048; H04B 1/7156; H04L 5/0094; H04W 72/23

(57) ABSTRACT

Methods, systems, and devices for wireless communications are described. A user equipment (UE) may receive a first control signal indicating a first configuration for a sub-band group (SBG) including multiple sub-bands. The UE may receive a second control signal indicating a second configuration for synchronization signal blocks (SSBs) over the sub-bands of the (SBG). Each of the SSBs may include a same cell identifier. The UE may measure, via one or more sub-bands of the SBG, one or more SSBs in accordance with at least one of the first configuration, the second configuration, or a combination thereof.

### FIELD OF TECHNOLOGY

The following relates to wireless communications, including synchronization signal block transmission for flexible spectrum integration.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support synchronization signal block (SSB) transmission for flexible spectrum integration. A network node may configure a user equipment (UE) with a virtual cell including one or more sub-band groups (SBGs), each of which may include multiple sub-bands. The network node may indicate a measurement configuration for each SBG to the UE. In some examples, the network node may indicate an intra-SBG frequency hopping configuration to the UE. For example, the network node may transmit a first SSB burst via a first sub-band of an SBG during a first interval, then the network node may transmit a second SSB burst via a second sub-band of the SBG during a second interval. The UE may monitor for an SSB burst of a sub-band within the active bandwidth part of the UE based on the measurement configuration. In some examples, the network node may sweep the beams of an SSB burst across sub-bands of an SBG. For example, the network node may transmit a first SSB of an SSB burst via a first sub-band of an SBG, and the network node may transmit a second SSB of the SSB burst via a second sub-band of the SBG. In some examples, the network node may use the same SSB beam for the same sub-band for multiple occasions. In some examples, the network node may cyclically sweep the SSB beams for the sub-bands across occasions. The network node may indicate the SSB sweeping pattern or cyclical rotation of the SSB sweeping pattern to the UE. In some examples, the network node may transmit cell defining SSBs or non-cell defining SSBs for SBG measurement.

A method for wireless communications by a UE is described. The method may include receiving a first control signal indicating a first configuration for an SBG including a set of multiple sub-bands, receiving a second control signal indicating a second configuration for a set of multiple SSBs over the set of multiple sub-bands of the SBG, each of the set of multiple SSBs including a same cell identifier, and measuring, via one or more sub-bands of the SBG, one or more SSBs of the set of multiple SSBs in accordance with at least one of the first configuration, the second configuration, or a combination thereof.

A UE for wireless communications is described. The UE may include one or more memories storing processor executable code, and one or more processors coupled with the one or more memories. The one or more processors may individually or collectively be operable to execute the code to cause the UE to receive a first control signal indicating a first configuration for an SBG including a set of multiple sub-bands, receive a second control signal indicating a second configuration for a set of multiple SSBs over the set of multiple sub-bands of the SBG, each of the set of multiple SSBs including a same cell identifier, and measure, via one or more sub-bands of the SBG, one or more SSBs of the set of multiple SSBs in accordance with at least one of the first configuration, the second configuration, or a combination thereof.

Another UE for wireless communications is described. The UE may include means for receiving a first control signal indicating a first configuration for an SBG including a set of multiple sub-bands, means for receiving a second control signal indicating a second configuration for a set of multiple SSBs over the set of multiple sub-bands of the SBG, each of the set of multiple SSBs including a same cell identifier, and means for measuring, via one or more sub-bands of the SBG, one or more SSBs of the set of multiple SSBs in accordance with at least one of the first configuration, the second configuration, or a combination thereof.

A non-transitory computer-readable medium storing code for wireless communications is described. The code may include instructions executable by one or more processors to receive a first control signal indicating a first configuration for an SBG including a set of multiple sub-bands, receive a second control signal indicating a second configuration for a set of multiple SSBs over the set of multiple sub-bands of the SBG, each of the set of multiple SSBs including a same cell identifier, and measure, via one or more sub-bands of the SBG, one or more SSBs of the set of multiple SSBs in accordance with at least one of the first configuration, the second configuration, or a combination thereof.

In some examples of the method, UEs, and non-transitory computer-readable medium described herein, the second control signal indicates a frequency hopping pattern for the set of multiple SSBs and a first SSB burst may be associated with a first sub-band of the set of multiple sub-bands during a first time interval, and a second SSB burst may be associated with a second sub-band of the set of multiple sub-bands during a second time interval in accordance with the frequency hopping pattern.

In some examples of the method, UEs, and non-transitory computer-readable medium described herein, measuring the one or more SSBs may include operations, features, means, or instructions for receiving a first SSB burst via a first sub-band of the set of multiple sub-bands in accordance with the second configuration, where the first sub-band may be within an active bandwidth part of the UE.

Some examples of the method, UEs, and non-transitory computer-readable medium described herein may further include operations, features, means, or instructions for receiving a second SSB burst via a second sub-band of the set of multiple sub-bands, where the second sub-band may be within the active bandwidth part of the UE.

In some examples of the method, UEs, and non-transitory computer-readable medium described herein, a periodicity of an SSB burst associated with a sub-band of the SBG may be based on a quantity of the set of multiple sub-bands in the SBG.

In some examples of the method, UEs, and non-transitory computer-readable medium described herein, the second control signal indicates a beam sweeping pattern for the set of multiple SSBs across the set of multiple sub-bands, a first SSB of an SSB burst may be associated with a first sub-band of the set of multiple sub-bands, and a second SSB of the SSB burst may be associated with a second sub-band of the set of multiple sub-bands.

In some examples of the method, UEs, and non-transitory computer-readable medium described herein, the second control signal indicates a first bitmap that maps at least the first SSB to the first sub-band and a second bitmap that maps at least the second SSB to the second sub-band.

In some examples of the method, UEs, and non-transitory computer-readable medium described herein, a quantity of SSBs associated with the first sub-band may be based on a bandwidth size of the first sub-band.

Some examples of the method, UEs, and non-transitory computer-readable medium described herein may further include operations, features, means, or instructions for receiving, via a first sub-band of the set of multiple sub-bands, a first SSB of an SSB burst during a first time interval in accordance with the second configuration, where remaining synchronization blocks of the SSB burst may be associated with different sub-bands of the set of multiple sub-bands and receiving, via the first sub-band, the first SSB during a second time interval in accordance with the second configuration.

In some examples of the method, UEs, and non-transitory computer-readable medium described herein, the second control signal indicates a cyclic beam sweeping pattern for the set of multiple SSBs across the set of multiple sub-bands and a set of multiple intervals.

In some examples of the method, UEs, and non-transitory computer-readable medium described herein, measuring the one or more SSBs may include operations, features, means, or instructions for receiving, via a first sub-band of the set of multiple sub-bands, a first SSB of an SSB burst during a first time interval in accordance with the second configuration and receiving, via the first sub-band, a second SSB of the SSB burst in accordance with the second configuration.

Some examples of the method, UEs, and non-transitory computer-readable medium described herein may further include operations, features, means, or instructions for receiving an indication that SSBs received via a first sub-band may be quasi co-located with a data channel, a control channel, or a reference signal, or any combination thereof, on a second sub-band.

In some examples of the method, UEs, and non-transitory computer-readable medium described herein, the second control signal indicates one or more beam bitmaps, one or more transmit powers, one or more time offsets, or one or more periodicities, or any combination thereof, for the set of multiple SSBs.

In some examples of the method, UEs, and non-transitory computer-readable medium described herein, the second control signal indicates a first set of parameters for cell-defining SSBs and a second set of parameters for non-cell defining SSBs.

In some examples of the method, UEs, and non-transitory computer-readable medium described herein, a first sub-band of the set of multiple sub-bands may be associated with non-cell defining SSBs, and a second sub-band of the set of multiple sub-bands may be associated with cell defining SSBs.

In some examples of the method, UEs, and non-transitory computer-readable medium described herein, the one or more SSBs include one or more cell defining SSBs or one or more non-cell defining SSBs, or both.

Some examples of the method, UEs, and non-transitory computer-readable medium described herein may further include operations, features, means, or instructions for transmitting a measurement report based on measuring the one or more SSBs.

A method for wireless communications by a network node is described. The method may include transmitting a first control signal indicating a first configuration for an SBG including a set of multiple sub-bands, transmitting a second control signal indicating a second configuration for a set of multiple SSBs over the set of multiple sub-bands of the SBG, each of the set of multiple SSBs including a same cell identifier, and transmitting, over the set of multiple sub-bands of the SBG, the set of multiple SSBs in accordance with at least one of the first configuration, the second configuration, or a combination thereof.

A network node for wireless communications is described. The network node may include one or more memories storing processor executable code, and one or more processors coupled with the one or more memories. The one or more processors may individually or collectively be operable to execute the code to cause the network node to transmit a first control signal indicating a first configuration for an SBG including a set of multiple sub-bands, transmit a second control signal indicating a second configuration for a set of multiple SSBs over the set of multiple sub-bands of the SBG, each of the set of multiple SSBs including a same cell identifier, and transmit, over the set of multiple sub-bands of the SBG, the set of multiple SSBs in accordance with at least one of the first configuration, the second configuration, or a combination thereof.

Another network node for wireless communications is described. The network node may include means for transmitting a first control signal indicating a first configuration for an SBG including a set of multiple sub-bands, means for transmitting a second control signal indicating a second configuration for a set of multiple SSBs over the set of multiple sub-bands of the SBG, each of the set of multiple SSBs including a same cell identifier, and means for transmitting, over the set of multiple sub-bands of the SBG, the set of multiple SSBs in accordance with at least one of the first configuration, the second configuration, or a combination thereof.

A non-transitory computer-readable medium storing code for wireless communications is described. The code may include instructions executable by one or more processors to transmit a first control signal indicating a first configuration for an SBG including a set of multiple sub-bands, transmit a second control signal indicating a second configuration for a set of multiple SSBs over the set of multiple sub-bands of the SBG, each of the set of multiple SSBs including a same cell identifier, and transmit, over the set of multiple sub-bands of the SBG, the set of multiple SSBs in accordance with at least one of the first configuration, the second configuration, or a combination thereof.

In some examples of the method, network nodes, and non-transitory computer-readable medium described herein, the second control signal indicates a frequency hopping pattern for the set of multiple SSBs and a first SSB burst may be associated with a first sub-band of the set of multiple sub-bands during a first time interval, and a second SSB burst may be associated with a second sub-band of the set of multiple sub-bands during a second time interval in accordance with the frequency hopping pattern.

In some examples of the method, network nodes, and non-transitory computer-readable medium described herein, measuring the one or more SSBs may include operations, features, means, or instructions for transmitting a first SSB burst via a first sub-band of the set of multiple sub-bands during a first occasion in accordance with the second configuration; and transmitting a second SSB burst via a second sub-band of the set of multiple sub-bands during a second occasion in accordance with the second configuration.

In some examples of the method, network nodes, and non-transitory computer-readable medium described herein, a periodicity of an SSB burst associated with a sub-band of the SBG may be based on a quantity of the set of multiple sub-bands in the SBG.

In some examples of the method, network nodes, and non-transitory computer-readable medium described herein, the second control signal indicates a beam sweeping pattern for the set of multiple SSBs across the set of multiple sub-bands, a first SSB of an SSB burst may be associated with a first sub-band of the set of multiple sub-bands, and a second SSB of the SSB burst may be associated with a second sub-band of the set of multiple sub-bands.

In some examples of the method, network nodes, and non-transitory computer-readable medium described herein, the second control signal indicates a first bitmap that maps at least the first SSB to the first sub-band and a second bitmap that maps at least the second SSB to the second sub-band.

In some examples of the method, network nodes, and non-transitory computer-readable medium described herein, a quantity of SSBs associated with the first sub-band may be based on a bandwidth size of the first sub-band.

Some examples of the method, network nodes, and non-transitory computer-readable medium described herein may further include operations, features, means, or instructions for transmitting, via a first sub-band of the set of multiple sub-bands using a first beam, a first SSB of an SSB burst during a first time interval in accordance with the second configuration and transmitting, via a second sub-band of the set of multiple sub-bands using a second beam, a second SSB of the SSB burst during the first time interval in accordance with the second configuration.

Some examples of the method, network nodes, and non-transitory computer-readable medium described herein may further include operations, features, means, or instructions for transmitting, via the first sub-band of the set of multiple sub-bands using the first beam, a third SSB of a second SSB burst during a second time interval in accordance with the second configuration.

Some examples of the method, network nodes, and non-transitory computer-readable medium described herein may further include operations, features, means, or instructions for transmitting, via the first sub-band of the set of multiple sub-bands using the second beam, a third SSB of a second SSB burst during a second time interval in accordance with the second configuration.

In some examples of the method, network nodes, and non-transitory computer-readable medium described herein, the second control signal indicates a cyclic beam sweeping pattern for the set of multiple SSBs across the set of multiple sub-bands and a set of multiple intervals.

Some examples of the method, network nodes, and non-transitory computer-readable medium described herein may further include operations, features, means, or instructions for transmitting an indication that SSBs transmitted via a first sub-band may be quasi co-located with a data channel, a control channel, or a reference signal, or any combination thereof, on a second sub-band.

Some examples of the method, network nodes, and non-transitory computer-readable medium described herein may further include operations, features, means, or instructions for receiving a measurement report based on one or more SSBs of the set of multiple SSBs.

### BRIEF DESCRIPTION OF THE DRAWINGS

FIG. 1 shows an example of a wireless communications system that supports synchronization signal block (SSB) transmission for flexible spectrum integration in accordance with one or more aspects of the present disclosure.

FIG. 2 shows an example of a wireless communications system that supports SSB transmission for flexible spectrum integration in accordance with one or more aspects of the present disclosure.

FIG. 3 shows an example of an intra-sub-band group (SBG) frequency hopping configuration that supports SSB transmission for flexible spectrum integration in accordance with one or more aspects of the present disclosure.

FIG. 4 shows an example of an intra-SBG fixed beam sweeping configuration that supports SSB transmission for flexible spectrum integration in accordance with one or more aspects of the present disclosure.

FIG. 5 shows an example of an intra-SBG cyclical beam sweeping configuration that supports SSB transmission for flexible spectrum integration in accordance with one or more aspects of the present disclosure.

FIG. 6 shows an example of a joint scheduling configuration that supports SSB transmission for flexible spectrum integration in accordance with one or more aspects of the present disclosure.

FIG. 7 shows an example of a process flow that supports SSB transmission for flexible spectrum integration in accordance with one or more aspects of the present disclosure.

FIGS. 8 and 9 show block diagrams of devices that support SSB transmission for flexible spectrum integration in accordance with one or more aspects of the present disclosure.

FIG. 10 shows a block diagram of a communications manager that supports SSB transmission for flexible spectrum integration in accordance with one or more aspects of the present disclosure.

FIG. 11 shows a diagram of a system including a device that supports SSB transmission for flexible spectrum integration in accordance with one or more aspects of the present disclosure.

FIGS. 12 and 13 show block diagrams of devices that support SSB transmission for flexible spectrum integration in accordance with one or more aspects of the present disclosure.

FIG. 14 shows a block diagram of a communications manager that supports SSB transmission for flexible spectrum integration in accordance with one or more aspects of the present disclosure.

FIG. 15 shows a diagram of a system including a device that supports SSB transmission for flexible spectrum integration in accordance with one or more aspects of the present disclosure.

FIGS. 16 through 20 show flowcharts illustrating methods that support SSB transmission for flexible spectrum integration in accordance with one or more aspects of the present disclosure.

### DETAILED DESCRIPTION

In some wireless communications systems, a network node may communicate with a user equipment (UE) via a virtual cell over multiple sub-bands. The virtual cell may be formed by flexible spectrum integration. For example, a network node may configure the UE with a virtual cell including one or more sub-band groups (SBGs). A sub-band of an SBG may have different restrictions than a component carrier configured for carrier aggregation. For example, a sub-band of an SBG may have a smaller bandwidth than a minimum carrier bandwidth for a component carrier in carrier aggregation, or a sub-band may be configured in a gap between two adjacent radio frequency spectrum bands. In some examples, the UE may measure synchronization signals in a synchronization signal block (SSB) on the sub-bands of a virtual cell for time and frequency synchronization, power control, Radio Link Management (RLM), random access occasion selection, mobility, or any combination thereof. However, techniques used to transmit SSBs for other configurations may be inefficient for flexible spectrum integration or virtual cells. For example, transmitting an SSB burst simultaneously on each sub-band of an SBG may increase network energy consumption and reduce spectral efficiency. If a network node periodically broadcasts an SSB burst on a single sub-band, the sub-band where the SSB burst is transmitted may be far from an active bandwidth part of the UE, and information obtained by measuring the SSB burst may not be reliable for other sub-bands in the active bandwidth part of the UE.

The present disclosure relates to SSB transmission via sub-bands of a virtual cell and, more specifically, to configuring a pattern for SSB transmission via sub-bands of a SBG associated with a virtual cell. For example, a network node may configure a UE with a virtual cell including one or more SBGs, each of which may include multiple sub-bands. The network node may indicate a measurement configuration for each SBG to the UE. In some examples, the network node may indicate an intra-SBG frequency hopping configuration to the UE. For example, the network node may transmit a first SSB burst via a first sub-band of an SBG during a first interval, then the network node may transmit a second SSB burst via a second sub-band of the SBG during a second interval. The UE may monitor for an SSB burst of a sub-band within the active bandwidth part of the UE based on the measurement configuration. In some examples, the network node may sweep the beams of an SSB burst across sub-bands of an SBG. For example, the network node may transmit a first SSB of an SSB burst via a first sub-band of an SBG, and the network node may transmit a second SSB of the SSB burst via a second sub-band of the SBG. In some examples, the network node may transmit using the same SSB beams for the same sub-band over multiple occasions. In some examples, the network node may cyclically rotate the SSB beams across occasions. The network node may indicate the SSB sweeping pattern or cyclical rotation of the SSB sweeping pattern to the UE. In some examples, the network node may transmit cell defining SSBs or non-cell defining SSBs for SBG measurement.

Aspects of the disclosure are initially described in the context of wireless communications systems. Aspects of the disclosure are further illustrated by and described with reference to apparatus diagrams, system diagrams, and flowcharts that relate to SSB transmission for flexible spectrum integration.

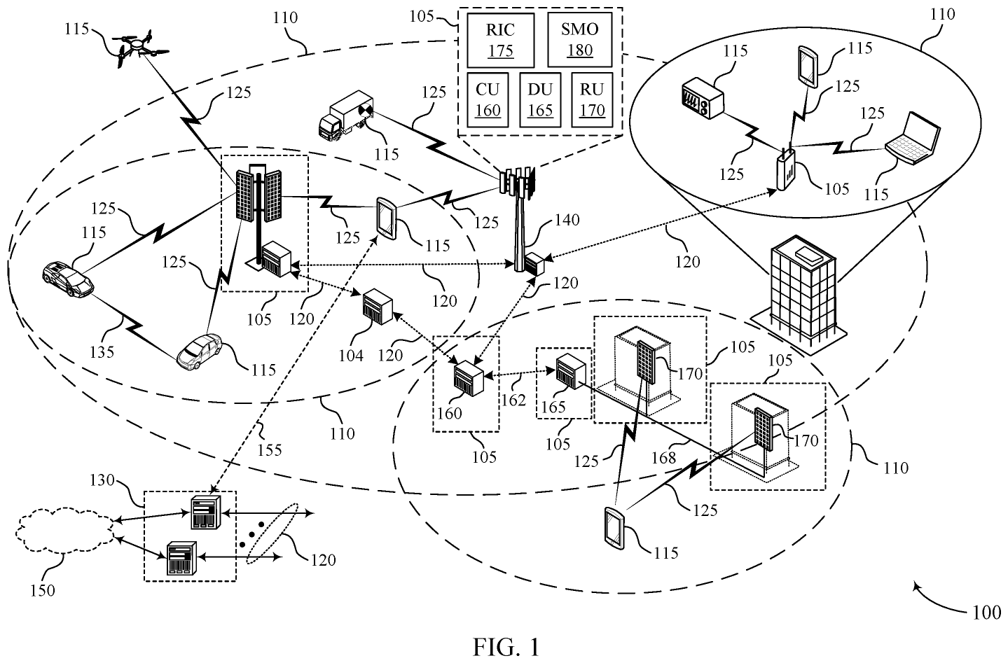

FIG. 1 shows an example of a wireless communications system 100 that supports SSB transmission for flexible spectrum integration in accordance with one or more aspects of the present disclosure. The wireless communications system 100 may include one or more devices, such as one or more network devices (e.g., network nodes 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network nodes 105 may be dispersed throughout a geographic area to form the wireless communications system 100 and may include devices in different forms or having different capabilities. In various examples, a network node 105 may be referred to as a network element, a network entity, a mobility element, a radio access network (RAN) node, or network equipment, among other nomenclature. In some examples, network nodes 105 and UEs 115 may wirelessly communicate via communication link(s) 125 (e.g., a radio frequency (RF) access link). For example, a network node 105 may support a coverage area 110 (e.g., a geographic coverage area) over which the UEs 115 and the network node 105 may establish the communication link(s) 125. The coverage area 110 may be an example of a geographic area over which a network node 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network nodes 105), as shown in FIG. 1.

As described herein, a node of the wireless communications system 100, which may be referred to as a network node, or a wireless node, may be a network node 105 (e.g., any network node described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network node 105. As another example, a first node may be configured to communicate with a second node or a third node. In one aspect of this example, the first node may be a UE 115, the second node may be a network node 105, and the third node may be a UE 115. In another aspect of this example, the first node may be a UE 115, the second node may be a network node 105, and the third node may be a network node 105. In yet other aspects of this example, the first, second, and third nodes may be different relative to these examples. Similarly, reference to a UE 115, network node 105, apparatus, device, computing system, or the like may include disclosure of the UE 115, network node 105, apparatus, device, computing system, or the like being a node. For example, disclosure that a UE 115 is configured to receive information from a network node 105 also discloses that a first node is configured to receive information from a second node.

In some examples, network nodes 105 may communicate with a core network 130, or with one another, or both. For example, network nodes 105 may communicate with the core network 130 via backhaul communication link(s) 120 (e.g., in accordance with an S1, N2, N3, or other interface protocol). In some examples, network nodes 105 may communicate with one another via backhaul communication link(s) 120 (e.g., in accordance with an X2, Xn, or other interface protocol) either directly (e.g., directly between network nodes 105) or indirectly (e.g., via the core network 130). In some examples, network nodes 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network nodes 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network node 105 (e.g., a base station 140) may be implemented in an aggregated (e.g., monolithic, standalone) base station architecture, which may be configured to utilize a protocol stack that is physically or logically integrated within one network node (e.g., a network node 105 or a single RAN node, such as a base station 140).

In some examples, a network node 105 may be implemented in a disaggregated architecture (e.g., a disaggregated base station architecture, a disaggregated RAN architecture), which may be configured to utilize a protocol stack that is physically or logically distributed among multiple network entities (e.g., network nodes 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network node 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network nodes 105 in a disaggregated RAN architecture may be co-located, or one or more components of the network nodes 105 may be located in distributed locations (e.g., separate physical locations). In some examples, one or more of the network nodes 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network nodes 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network nodes 105 (e.g., network nodes 105 or IAB node(s) 104) may be partially controlled by each other. The IAB node(s) 104 may be referred to as a donor entity or an IAB donor. A DU 165 or an RU 170 may be partially controlled by a CU 160 associated with a network node 105 or base station 140 (such as a donor network node or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network node 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network nodes 105 and the network equipment including macro eNBs or gNBs, small cell eNBs or gNBs, or relay base stations, among other examples, as shown in FIG. 1.

The UEs 115 and the network nodes 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Communication between a network node 105 and other devices may refer to communication between the devices and any portion (e.g., entity, sub-entity) of a network node 105. For example, the terms “transmitting,” “receiving,” or “communicating,” when referring to a network node 105, may refer to any portion of a network node 105 (e.g., a base station 140, a CU 160, a DU 165, a RU 170) of a RAN communicating with another device (e.g., directly or via one or more other network entities, such as one or more of the network nodes 105).

The communication link(s) 125 of the wireless communications system 100 may include downlink transmissions (e.g., forward link transmissions) from a network node 105 to a UE 115, uplink transmissions (e.g., return link transmissions) from a UE 115 to a network node 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network nodes 105, the UEs 115, or both) may have hardware configurations that support communications using a particular carrier bandwidth or may be configurable to support communications using one of a set of carrier bandwidths. In some examples, the wireless communications system 100 may include network nodes 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network nodes 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and Ne may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network node 105 may provide communication coverage via one or more cells, for example a macro cell, a small cell, a hot spot, or other types of cells, or any combination thereof. The term “cell” may refer to a logical communication entity used for communication with a network node 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network node 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network node 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network node 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network node 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network node (e.g., a network node 105). In some other examples, overlapping coverage areas, such as a coverage area 110, associated with different technologies may be supported by different network entities (e.g., the network nodes 105). The wireless communications system 100 may include, for example, a heterogeneous network in which different types of the network nodes 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network node 105 (e.g., a base station 140, an RU 170), which may support aspects of such D2D communications being configured by (e.g., scheduled by) the network node 105. In some examples, one or more UEs 115 of such a group may be outside the coverage area 110 of a network node 105 or may be otherwise unable to or not configured to receive transmissions from a network node 105. In some examples, groups of the UEs 115 communicating via D2D communications may support a one-to-many (1:M) system in which each UE 115 transmits to one or more of the UEs 115 in the group. In some examples, a network node 105 may facilitate the scheduling of resources for D2D communications. In some other examples, D2D communications may be carried out between the UEs 115 without an involvement of a network node 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network nodes 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network nodes 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network nodes 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network nodes 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network node 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network node 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network node 105 may be located at diverse geographic locations. A network node 105 may include an antenna array with a set of rows and columns of antenna ports that the network node 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network nodes 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network node 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network node 105 or a UE 115 may use beam sweeping techniques as part of beamforming operations. For example, a network node 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network node 105 multiple times along different directions. For example, the network node 105 may transmit a signal according to different beamforming weight sets associated with different directions of transmission. Transmissions along different beam directions may be used to identify (e.g., by a transmitting device, such as a network node 105, or by a receiving device, such as a UE 115) a beam direction for later transmission or reception by the network node 105.

Some signals, such as data signals associated with a particular receiving device, may be transmitted by a transmitting device (e.g., a network node 105 or a UE 115) along a single beam direction (e.g., a direction associated with the receiving device, such as another network node 105 or UE 115). In some examples, the beam direction associated with transmissions along a single beam direction may be determined based on a signal that was transmitted along one or more beam directions. For example, a UE 115 may receive one or more of the signals transmitted by the network node 105 along different directions and may report to the network node 105 an indication of the signal that the UE 115 received with a highest signal quality or an otherwise acceptable signal quality.

In some examples, transmissions by a device (e.g., by a network node 105 or a UE 115) may be performed using multiple beam directions, and the device may use a combination of digital precoding or beamforming to generate a combined beam for transmission (e.g., from a network node 105 to a UE 115). The UE 115 may report feedback that indicates precoding weights for one or more beam directions, and the feedback may correspond to a configured set of beams across a system bandwidth or one or more sub-bands. The network node 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network node 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network node 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network node 105 or a core network 130 supporting radio bearers for user plane data. A PHY layer may map transport channels to physical channels.

The UEs 115 and the network nodes 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The wireless communications system 100 may use carrier aggregation to aggregate multiple continuous or non-continuous carriers. The wireless communications system 100 also may support flexible spectrum integration. Flexible spectrum integration is a spectrum aggregation technique and may be used in addition to, or alternative to, carrier aggregation. In some examples, flexible spectrum integration may provide reduced bandwidth adaptation latency, reduced signaling overhead, and improved spectrum utilization. A virtual cell formed by flexible spectrum integration may include multiple sub-bands. Each sub-band may include multiple aggregated component carriers. In some examples, flexible spectrum integration may be implemented in scenarios which are not supported by carrier aggregation. Different from carrier aggregation configurations, however, the component carriers of a sub-band of the virtual cell may be continuous (e.g., without gaps, ignoring guard band restrictions), and may support channel bandwidths which may otherwise by unsupported by carrier aggregation (such as resources of a frequency gap between two component carriers belonging to different frequency bands). For example, a virtual cell formed by flexible spectrum integration may include non-contiguous sub-bands, and the sub-bands may have a smaller bandwidth than a minimum carrier bandwidth for a component carrier for carrier aggregation. In another example, a virtual cell may include three non-contiguous sub-bands, where a first and a third sub-band are configured, respectively, in two adjacent radio frequency spectrum bands, and a second sub-band is configured in a gap between the two adjacent radio frequency spectrum bands.

In some examples, a virtual cell may include one or more SBGs. An SBG may include multiple sub-bands. In some examples the sub-bands of an SBG may be in different radio frequency spectrum bands, or one or more sub-bands of the SBG may be in a same radio frequency spectrum band. In some examples, the sub-bands of an SBG may be within a maximum radio frequency bandwidth of a single transmit/receive chain.

A UE 115 may measure reference signals to perform time and frequency synchronization, power control, RLM procedures, RACH procedures such as random access occasion selection, or mobility. For example, a network node 105 may transmit SSBs in an SSB burst, and the UE 115 may measure an SSB of the SSB burst to perform one or more these procedures. An SSB burst may include multiple SSBs, each of which may correspond to a different beam direction. In some examples, an SSB may include reference signals or synchronization signals, or both. For example, an SSB may include a primary synchronization signal (PSS), a secondary synchronization signal (SSS), and a physical broadcast channel (PBCH). A network node 105 may transmit the SSB burst over sub-bands of a SBG.

In some examples, a network node 105 may transmit SSB bursts across all sub-bands of an SBG simultaneously. For example, the network node 105 may transmit SSB bursts with a same time offset and periodicity on each sub-band of a virtual cell. In some examples, however, transmitting SSB bursts simultaneously on each sub-band may increase network energy consumption and reduce spectral efficiency. In some examples, a network node 105 may periodically broadcast a single SSB burst on a sub-band to UEs 115 operating on different sub-bands. The UEs 115 may switch to the sub-band with the SSB burst and measure the SSBs. In some examples, the sub-band with the SSB burst may be outside of an active BWP of the UEs 115 or activated sub-bands of the UEs 115. If the sub-band with the SSB burst and the active sub-bands of a UE 115 are far apart in frequency, propagation profiles may be different for the sub-band with the SSB burst and the active sub-bands of the UE 115. If the propagation profiles are significantly different, measurements performed on the SSB burst may not be reliable for the active sub-bands of the UE 115. In some examples, time domain filtering may not be effective for interferences caused by adjacent channels or cross-links and slow and frequency-selective fading.

The wireless communications system 100 may support techniques for transmitting SSB bursts per SBG. In some examples, a network node 105 may transmit SSB bursts using intra-frequency hopping. For example, the network node may transmit a first SSB burst over a first sub-band of an SBG during a first interval, then the network node 105 may transmit a second SSB burst via a second sub-band of the SBG during a second interval. The UE 115 may monitor for an SSB burst of a sub-band within the active bandwidth part of the UE 115 based on the measurement configuration. In some examples, the network node 105 may sweep the beams of an SSB burst across sub-bands of an SBG. For example, the network node 105 may transmit a first SSB of an SSB burst via a first sub-band of an SBG, and the network node 105 may transmit a second SSB of the SSB burst via a second sub-band of the SBG. In some examples, the network node 105 may transmit the same SSBs via the same sub-bands for multiple periods. In some examples, the network node 105 may cyclically rotate the SSBs, such that the network node transmits the second SSB burst via the first sub-band during a second period. The network node 105 may indicate the SSB sweeping pattern or cyclical rotation of the SSB sweeping pattern to the UE 115. In some examples, the network node 105 may transmit cell defining SSBs or non-cell defining SSBs for SBG measurement.

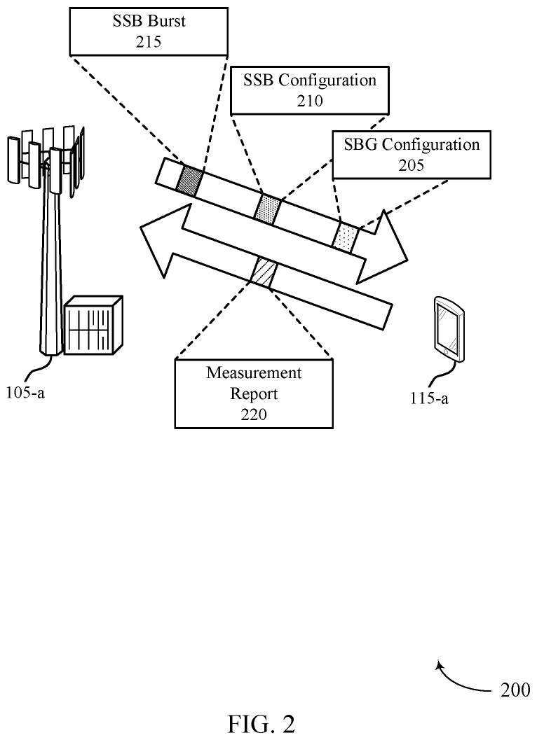

FIG. 2 shows an example of a wireless communications system 200 that supports SSB transmission for flexible spectrum integration in accordance with one or more aspects of the present disclosure. The wireless communications system 200 may implement aspects of a wireless communications system 100. For example, the wireless communications system 200 may include a UE 115-a and a network node 105-a, which may be respective examples of a UE 115 and a network node 105 as described with reference to FIG. 1.

The UE 115-a and the network node 105-a may support flexible spectrum integration. The network node 105-a may configure the UE 115-a with a virtual cell including one or more sub-bands using flexible spectrum integration. An aggregated bandwidth of the virtual cell may span the sub-bands belonging to the virtual cell.

The virtual cell may include one or more SBGs, and each of the one or more SBGs may include one or more sub-bands. For example, the network node 105-a may transmit a control message indicating an SBG configuration 205 to the UE 115-a. The SBG configuration may indicate parameters for one or more sub-bands of an SBG. In some examples, the control message may include an SBG configuration for multiple SBGs. Additionally, or alternatively, the control message may include a configuration for a virtual cell. For example, the configuration for the virtual cell may include the SBG configuration 205, or the configuration for the virtual cell may indicate which SBGs correspond to the virtual cell.

The UE 115-a may measure reference signals to obtain measurements for the virtual cell or a sub-band of the virtual cell, or both. For example, the network node 105-a may transmit an SSB burst 215 including multiple SSBs, and the UE 115-a may measure one or more SSBs of the SSB burst 215. The UE 115-a may measure the reference signals for power control, RLM, RACH determinations (e.g., random access occasion selection), and mobility (e.g., lower layer-triggered mobility or conditional handoff).

The network node 105-a may transmit a control message indicating an SSB configuration 210 to the UE 115-a. The SSB configuration 210 may indicate a transmission pattern for SSB bursts. In some examples, the SSB configuration 210 may indicate a measurement configuration for the UE 115-a to receive and measure the SSB bursts. In some examples, the SSB configuration 210 may be associated with an SBG. For example, the SSB configuration 210 may indicate a pattern for transmission of SSBs over sub-bands of an SBG. In some examples, the SSB configuration 210 may be associated with the virtual cell. In some examples, the virtual cell may include multiple SBGs, and each SBG may have a respective SSB configuration 210. For example, different SBGs of the virtual cell may have different patterns of SSB bursts or different SSB configurations.

In some examples, each SSB of an SSB burst for a virtual cell, or measurement of a virtual cell, may include a same cell identifier. For example, each SSB of the SSB burst transmitted by the network node 105-a for the virtual cell may include a same cell identifier associated with the virtual cell.

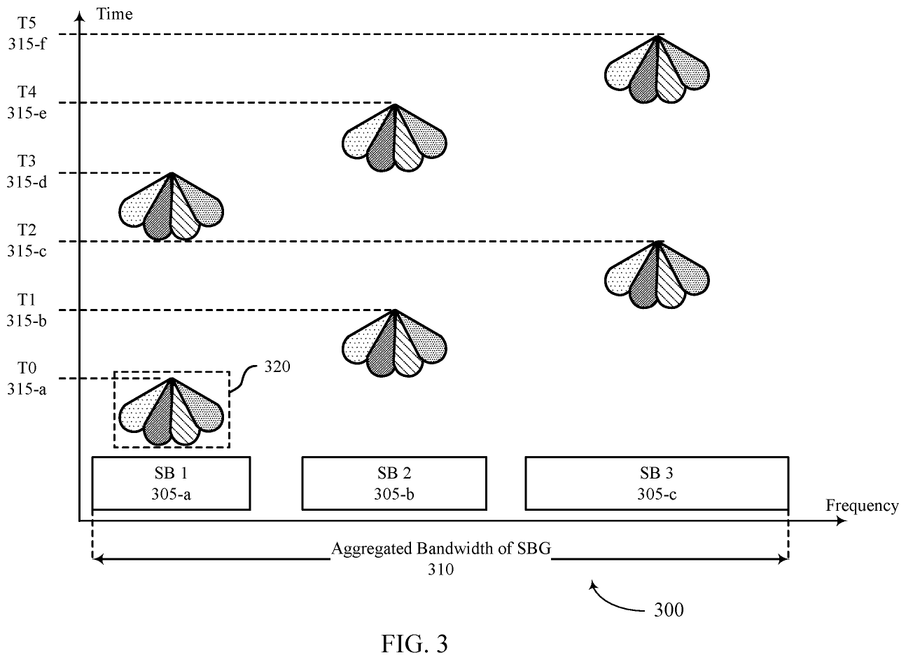

In some examples, the SSB configuration 210 may indicate an intra-SBG frequency hopping pattern for the SSB burst 215. The SBG configuration 205 may configure the UE 115-a with an SBG including multiple sub-bands. For example, the SBG may include N sub-bands. The network node 105-a may transmit SSB bursts with a nominal periodicity of T. In some examples, T may correspond to a quantity of radio frames. If the UE 115-a is operating on an active BWP including a single sub-band of the SBG, the observed SSB periodicity may be N*T. If the UE 115-a is operating on an active BWP including the entire SBG (e.g., all sub-bands of the SBG), the SSB periodicity as observed by the UE 115-a may be T. For example, the network node 105-a may transmit a first SSB burst on a first sub-band of the SBG at a first occasion. At a second occasion, the network node 105-a may transmit a second SSB burst on a second sub-band of the SBG. The network node 105-a may hop across the sub-bands of the SBG and transmit SSB bursts. At occasion N+1, the network node 105-a may transmit an SSB burst on the first sub-band of the SBG again. An example of intra-SBG frequency hopping is described in more detail with reference to FIG. 3.

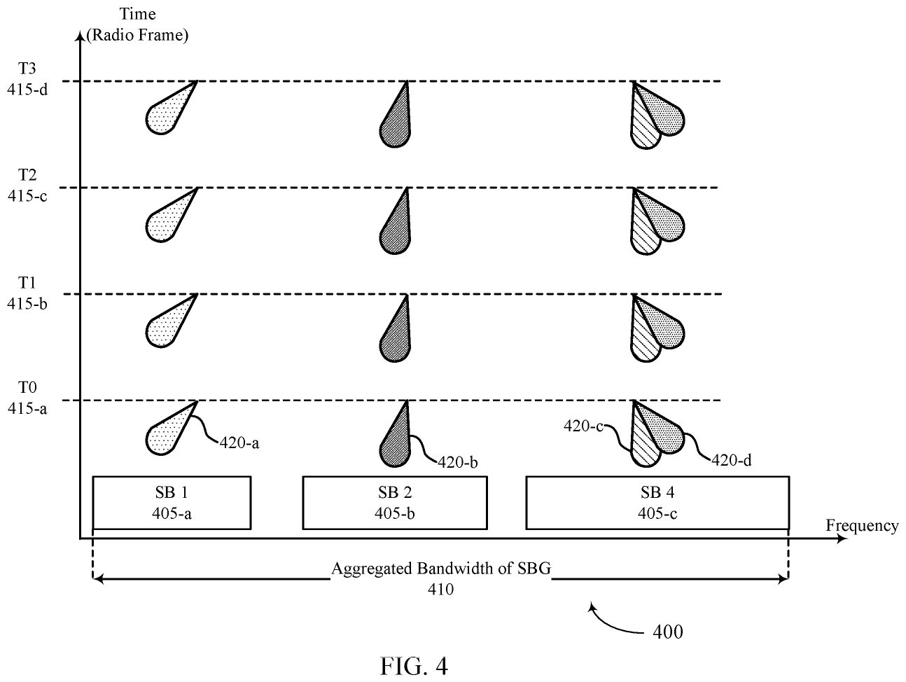

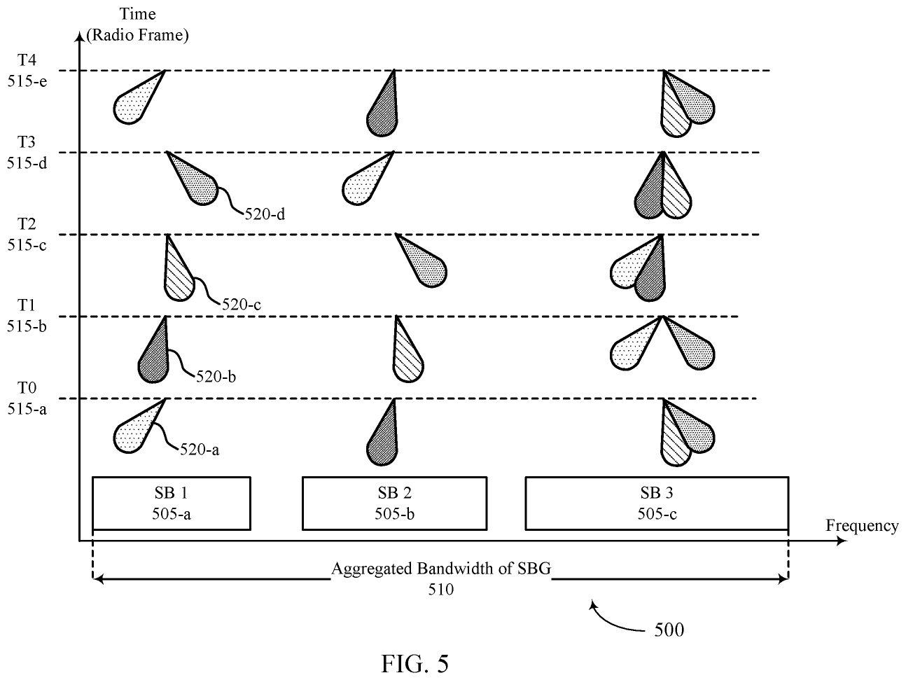

In some examples, the SSB configuration 210 may indicate an intra-SBG SSB beam sweeping pattern. Using an intra-SBG SSB beam sweeping pattern, the network node 105-a may transmit SSBs of an SSB burst across the sub-bands of an SBG. For example, the network node 105-a may transmit a first SSB of an SBB burst via a first sub-band of an SBG and a second SSB of the SSB burst via a second sub-band of the SBG. In some examples, the network node 105-a may indicate one or more bitmaps for the beam sweeping, such as a sub-band specific bitmap or an SBG specific bitmap, to the UE 115-a. The bitmaps may be indicated via the SSB configuration 210 or via separate signaling. For example, the bitmaps may be indicated via system information or an RRC message. The bitmaps may indicate how subsets of SSB beams are transmitted on the sub-bands of the SBG. Examples of intra-SBG SSB beam sweeping is described in more detail with reference to FIGS. 4 and 5.

The network node 105-a may transmit, and the UE 115-a may receive, cell defining SSBs or non-cell defining SSBs. A cell defining SSB may include additional information, such as remaining minimum system information (RMSI). A non-cell defining SSB may not include system information, such as RMSI or some system information blocks (SIBs), such as SIB1.

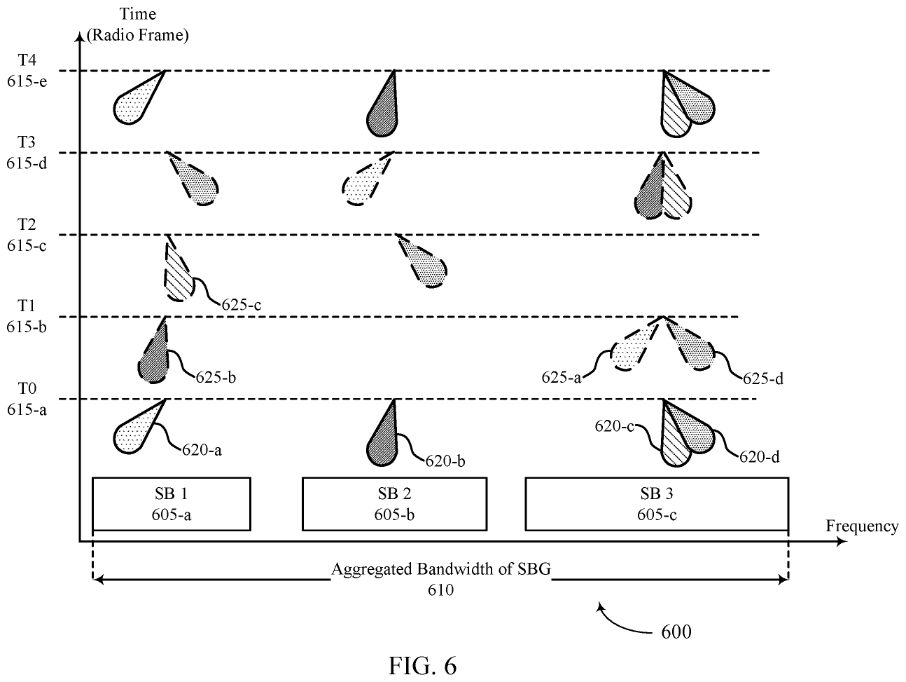

In some examples, cell defining SSBs and non-cell defining SSBs may be jointly scheduled. Both cell defining SSBs and non-cell defining SSBs may be configured on an activated sub-band or active BWP of a virtual cell. Beam bitmaps, transmit powers (e.g., absolute powers or power boosting levels), time offsets, periodicities, or any combination thereof, may be separately configured for cell defining and non-cell defining SSB beams on the same sub-band or SBG. For example, periodic cell defining SSBs may be transmitted on a wide-band sub-band, and non-cell defining SSBs may be dynamically configured for narrow-band sub-bands. In some examples, the network node 105-a may transmit periodic cell defining SSBs sparsely in time and space, and the network node 105-a may dynamically transmit non-cell defining SSBs in time, space, and frequency. An example of joint scheduling of cell defining SSBs and non-cell defining SSBs is described in more detail with reference to FIG. 6.

The UE 115-a may receive the SBG configuration 205 and the SSB configuration 210 and monitor for SSBs in accordance with the SBG configuration 205 or the SSB configuration 210, or both. For example, the network node 105-a may transmit SSBs using one or more SSB beams via a sub-band that overlaps with the active BWP of the UE 115-a based on the SBG configuration 205. The UE 115-a may measure an SSB received via the sub-band based on the SBG configuration 205.

In some examples, the UE 115-a may transmit a measurement report 220 to the network node 105-a. For example, the UE 115-a may measure an SSB based on the SBG configuration 205 and the SSB configuration 210, and the UE 115-a may determine a cell quality for the virtual cell based on the measurement. The UE 115-a may transmit the measurement report 220 indicating the cell quality. In some examples, the UE 115-a may measure SSBs via multiple sub-bands of an SBG configured for the UE 115-a. The UE 115-a may average measurements across the multiple sub-bands, such that information in the measurement report 220 is based on the measurements across the multiple sub-bands.

FIG. 3 shows an example of an intra-SBG frequency hopping configuration 300 that supports SSB transmission for flexible spectrum integration in accordance with one or more aspects of the present disclosure. The intra-SBG frequency hopping configuration 300 may implement aspects of a wireless communications system 100 or a wireless communications system 200.

A network node 105 may configure a UE 115 with a virtual cell including one or more SBGs. Each SBG may include multiple sub-bands, or N sub-bands. For example, an SBG may include three sub-bands 305, including a first sub-band 305-a, a second sub-band 305-b, and a third sub-band 305-c. In other examples, SBGs may include different quantities of sub-bands. An aggregated bandwidth 310 of the SBG may span all bandwidths of the sub-bands 305 of the SBG.

In some examples, the network node 105 may periodically transmit an SSB burst 320. For example, the network node 105 may transmit an SSB burst 320 with a periodicity of T. In some examples, T may correspond to a quantity of radio frames. For example, the periodicity may be one radio frame, and the network node 105 may transmit an SSB burst 320 each radio frame. At a first occasion 315-a (e.g., T0 in FIG. 3), the network node 105 may transmit a first SSB burst 320, and the network node 105 may transmit a second SSB burst 320 at a second occasion 315-b (e.g., T1 in FIG. 3). In some examples, the network node 105 may transmit a first SSB burst 320 after a timing offset, T_{offset}. The timing offset may be from an activation of an SSB or SSB burst 320, a signal from the network node 105, a reference time, or any combination thereof.

The intra-SBG frequency hopping configuration 300 may include aspects of intra-SBG frequency hopping for SSB bursts. The network node 105 may transmit SSB bursts by frequency hopping around the sub-bands 305 of the SBG. For example, the network node 105 may transmit a first SSB burst 320 on the first sub-band 305-a during the first occasion 315-a, and the network node 105 may transmit a second SSB burst 320 on the second sub-band 305-b during a second occasion 315-b. After the network node 105 has transmitted an SSB burst 320 on each sub-band 305 of the SBG, the network node 105 may begin from the first sub-band 305-a at a next occasion 315. In the example of FIG. 3, the network node 105 may transmit an SSB burst 320 on the first sub-band 305-a during the first occasion 315-a and a fourth occasion 315-d, on the second sub-band 305-b during the second occasion 315-b and a fifth occasion 315-e, and on the third sub-band 305-c during the third occasion 315-c and a sixth occasion 315-f.

In some examples, the UE 115 may operate on an active BWP which includes a single sub-band. For example, the active BWP of the UE 115 may include the first sub-band 305-a. The observed SSB periodicity to the UE 115 (e.g., with a single sub-band in the active BWP of the UE 115) may be N*T. For example, at the first occasion 315-a, the UE 115-a may receive a first SSB burst 320 at time T_{offset}, and at the fourth occasion 315-d, the UE 115-a may receive a fourth SSB burst 320 at time T_{ofset}+3T.

In some examples, the UE 115 may operate on an active BWP which includes all of the sub-bands of the SBG. For example, the active BWP of the UE 115 may include the first sub-band 305-a, the second sub-band 305-b, and the third sub-band 305-c. The observed SSB periodicity to the UE 115 (e.g., with a single sub-band in the active BWP of the UE 115) may be T, as the UE 115 may receive one SSB burst on one sub-band 305 each occasion 315.

In some examples, the network node 105 may semi-statically enable or disable SSB bursts on a subset of sub-bands of the SBG. For example, the network node 105 may disable SSB burst transmission on the third sub-band 305-c. In some examples, disabling SSB burst transmission on a sub-band may reduce network-side energy consumption. The network node 105 may configure retuning gaps for UEs 115 operating on sub-bands without active SSB burst transmission, and these UEs 115 may retune to another sub-band of the SBG with SSB transmission to measure an SSB burst 320. In some examples, the network node 105 may configure the retuning gaps if, for example, retuning gaps are required by UE capability. The network node 105 may configure retuning gaps for the UE 115 via control signaling.

In some examples, the network node 105 may indicate the frequency hopping pattern of the SSBs. For example, the network node 105 may transmit system information (e.g., via a cell defining SSB), dedicated RRC signaling, a MAC control element (CE), downlink control information, a non-cell defining SSB, or any combination thereof, to indicate the frequency hopping pattern. In some examples, the UE 115 may monitor one set of SSB bursts on one sub-band in the active BWP of the UE 115. In some examples, the UE 115 may monitor multiple sets of SSB bursts across multiple sub-bands in the active BWP of the UE 115. If the UE 115 monitors multiple sets of SSB bursts, the UE 115 may average measurements across multiple sub-bands to determine cell quality for the virtual cell.

In some examples, an intra-SBG frequency hopping scheme may reduce a measurement gap or interruption time for measurements outside of an activated sub-band or active BWP of a UE 115. The intra-SBG frequency hopping scheme may provide higher reliability for L1 and L3 measurements if the UE 115 is experiencing slow and frequency selective fading or interference. For example, the UE 115 may experience greater frequency diversity gain inherent to the virtual cell to render metrics for cell quality measurements. Additionally, the intra-SBG frequency hopping scheme may enable the UE 115 to average interference measurements and improve frequency diversity for SSB reception.

FIG. 4 shows an example of an intra-SBG fixed beam sweeping configuration 400 that supports SSB transmission for flexible spectrum integration in accordance with one or more aspects of the present disclosure. The intra-SBG fixed beam sweeping configuration 400 may implement aspects of a wireless communications system 100 or a wireless communications system 200.

A network node 105 may configure a UE 115 with a virtual cell including one or more SBGs. Each SBG may include multiple sub-bands, or N sub-bands. For example, an SBG may include three sub-bands 405, including a first sub-band 405-a, a second sub-band 405-b, and a third sub-band 405-c. In other examples, SBGs may include different quantities of sub-bands. An aggregated bandwidth 410 of the SBG may span all bandwidths of the sub-bands 405 of the SBG.

In some examples, the network node 105 may periodically transmit an SSB burst. For example, the network node 105 may transmit an SSB burst with a periodicity of T. In some examples, T may correspond to a quantity of radio frames. For example, the periodicity may be one radio frame, and the network node 105 may transmit an SSB burst each radio frame. At a first occasion 415-a (e.g., T0 in FIG. 4), the network node 105 may transmit a first SSB burst, and the network node 105 may transmit a second SSB burst at a second occasion 415-b (e.g., T1 in FIG. 4). In some examples, the network node 105 may transmit a first SSB burst after a timing offset, T_{offset}. The timing offset may be from an activation of an SSB or SSB burst, a signal from the network node 105, a reference time, or any combination thereof.

The intra-SBG fixed beam sweeping configuration 400 may implement aspects of an intra-SBG SSB beam sweeping technique. For example, the SSB beams of an SSB burst may be transmitted across the sub-bands of an SBG. In the example of FIG. 4, a first SSB 420-a may be transmitted via the first sub-band 405-a, a second SSB 420-b may be transmitted via the second sub-band 405-b, and a third SSB 420-c and a fourth SSB 420-d may be transmitted via the third sub-band 405-c. In some examples, an SSB burst may include SSBs 420 which are not configured for or active for the SBG.

In the example of the intra-SBG fixed beam sweeping configuration 400, the network node 105 may transmit an SSB 420 on a sub-band 405 using a same SSB beam across for multiple occasions 415. For example, at a first occasion 415-a, the network node 105 may transmit a first SSB 420-a using a first SSB beam via the first sub-band 405-a. The network node 105 may transmit the first SSB 420-a using the first SSB beam via the first sub-band 405-a at a second occasion 415-b, a third occasion 415-c, and a fourth occasion 415-d. Similarly, the SSB beams used for the second sub-band 405-b and the third sub-band 405-c may remain fixed across different occasions. In some other examples, SSB beams may be cyclically swept across the sub-bands of an SBG. An example of an intra-SBG cyclical beam sweeping technique is described in more detail with reference to FIG. 5.

In some examples, the network node 105 may indicate one or more bitmaps for the beam sweeping to a UE 115. For example, the network node 105 may indicate a sub-band specific or an SBG specific bitmap, or both, for subsets of SSB beams transmitted on an SBG. In some examples, the one or more bitmaps may be indicated via a configuration for the SBG. Additionally, or alternatively, the one or more bitmaps may be indicated via separate signaling from the signaling indicating the configuration for the SBG. In some examples, the network node 105 may indicate the one or more bitmaps via control signaling, such as RRC signaling, or system information (e.g., indicated by the network node 105 in “SSB-PositionInBurst” in SI or RRC). In some examples, the network node 105 may indicate the one or more bitmaps via a cell defining SSB or a non-cell defining SSB.

In some examples, the network node 105 may enable or disable the SSB beam transmission on a subset of sub-bands. For example, the network node 105 may disable SSB transmission on the first sub-band 405-a, and the network node 105 may continue to transmit the second SSB 420-b on the second sub-band 405-b and continue to transmit the third SSB 420-c and the fourth SSB 420-d on the third sub-band 405-c. In some examples, the network node 105 may configure retuning gaps for a UE 115 operating on sub-bands with disabled SSBs, such that the UE 115 may measure SSBs on other sub-bands of the SBG.

In some examples, a quantity of SSBs transmitted on a sub-band 405 may be based on a bandwidth size of the sub-band 405. For example, the third sub-band 405-c may have a larger bandwidth than the first sub-band 405-a or the second sub-band 405-b. The network node 105 may transmit more SSBs on the third sub-band 405-c than the first sub-band 405-a or the second sub-band 405-b. For example, the network node 105 may transmit two SSBs on the third sub-band 405-c and one SSB on the first sub-band 405-a and the second sub-band 405-b.

In some examples, an SSB 420 on one sub-band 405 may be a quasi co-location source for signaling on another sub-band 405. For example, the network node 105 may indicate whether the first SSB 420-a received via the first sub-band 405-a can be used as a quasi co-location source for a data channel, a control channel, or reference signals on the second sub-band 405-b. In some examples, the network node 105 that an SSB beam on one sub-band cannot be used as a quasi co-location source for channels or reference signals on another sub-band.

An intra-SBG beam sweeping technique may enable radio resource management based on joint considerations of bandwidth and beam-width. For example, more beams may be configured on a sub-band 405 with a larger bandwidth to support more UEs 115. Additionally, the intra-SBG beam sweeping technique may provide flexibility for interference measurement. For example, different sets of SSB beams, with or without power boosting, may be transmitted on adjacent sub-bands or sub-bands which are adjacent to incumbent UEs 115 of a cell. In some examples, the intra-SBG beam sweeping technique may reduce overhead compared to utilizing an anchor sub-band.

FIG. 5 shows an example of an intra-SBG cyclical beam sweeping configuration 500 that supports SSB transmission for flexible spectrum integration in accordance with one or more aspects of the present disclosure. The intra-SBG cyclical beam sweeping configuration 500 may implement aspects of a wireless communications system 100 or a wireless communications system 200.

A network node 105 may configure a UE 115 with a virtual cell including one or more SBGs. Each SBG may include multiple sub-bands, or N sub-bands. For example, an SBG may include three sub-bands 505, including a first sub-band 505-a, a second sub-band 505-b, and a third sub-band 505-c. In other examples, SBGs may include different quantities of sub-bands. An aggregated bandwidth 510 of the SBG may span all bandwidths of the sub-bands 505 of the SBG.

In some examples, the network node 105 may periodically transmit an SSB burst. For example, the network node 105 may transmit an SSB burst with a periodicity of T. In some examples, T may correspond to a quantity of radio frames. For example, the periodicity may be one radio frame, and the network node 105 may transmit an SSB burst each radio frame. At a first occasion 515-a (e.g., T0 in FIG. 5), the network node 105 may transmit a first SSB burst, and the network node 105 may transmit a second SSB burst at a second occasion 515-b (e.g., T1 in FIG. 5). In some examples, the network node 105 may transmit a first SSB burst after a timing offset, T_{offset}. The timing offset may be from an activation of an SSB or SSB burst, a signal from the network node 105, a reference time, or any combination thereof.

The intra-SBG cyclical beam sweeping configuration 500 may implement aspects of an intra-SBG SSB beam sweeping technique, such as the intra-SBG fixed beam sweeping technique described with reference to FIG. 4. For example, the SSB beams of an SSB burst may be transmitted across the sub-bands of an SBG. In the example of the intra-SBG cyclical beam sweeping configuration 500, the SSB beams may be cyclically rotated or swept across the sub-bands 505 over different occasions 515.

For example, at a first occasion 515-a, the network node 105 may transmit a first SSB 520-a via the first sub-band 505-a using a first SSB beam. At a second occasion 515-b, the SSB beams have cycled across the sub-bands 505 of the SBG. For example, at the second occasion 515-b, the network node 105 may transmit a second SSB 520-b via the first sub-band 505-a using a second SSB beam. At a third occasion 515-c, the network node 105 may transmit a third SSB 520-c via the first sub-band 505-a using a third SSB beam, and the network node 105 may transmit a fourth SSB 520-d via the first sub-band using a fourth SSB beam at a fourth occasion 515-d. After the network node 105 cycles across all of the SSB beams configured for the SBG, the network node may transmit an SSB using the first SSB beam via the first sub-band 505-a again. For example, the network node 105 may transmit an SSB 520 via the first sub-band 505-a using the first SSB beam again at a fifth occasion 515-e (e.g., as four SSB beams are configured for the SBG).

Similar cyclic sweeping may be performed for the other sub-bands. For example, the network node 105 may transmit an SSB 520 using the second SSB beam via the second sub-band 505-b at the first occasion 515-a, and the network node 105 may cycle through the SSB beams for the second sub-band 505-b across the different occasions 515.

Similar to the intra-SBG fixed beam sweeping configuration 400 described with reference to FIG. 4, the network node 105 may indicate one or more bitmaps for the beam sweeping to a UE 115. For example, the network node 105 may indicate a sub-band specific or an SBG specific bitmap, or both, for subsets of SSB beams transmitted on an SBG. In the example of the intra-SBG cyclical beam sweeping configuration 500, the one or more bitmaps may be a cyclic bitmap configuration. For example, the one or more bitmaps may indicate which SSB beams are associated with which sub-bands 505, how the SSB beams cycle through the sub-bands 505 across different occasions 515, or both. The network node 105 may indicate the one or more bitmaps via control signaling, such as RRC signaling, or system information. In some examples, the network node 105 may indicate the one or more bitmaps via a cell defining SSB or a non-cell defining SSB. In some examples, the network node 105 may enable or disable the SSB beam transmission on a subset of sub-bands as described herein. In some examples, the network node 105 may configure retuning gaps for a UE 115 operating on sub-bands with disabled SSBs.

In some examples, a quantity of SSB beams for a sub-band 505 may be based on a bandwidth size of the sub-band 505. For example, the third sub-band 505-c may have a larger bandwidth than the first sub-band 505-a or the second sub-band 505-b. The network node 105 may transmit more SSBs on the third sub-band 505-c than the first sub-band 505-a or the second sub-band 505-b at each occasion 515. For example, the network node 105 may transmit two SSBs on the third sub-band 505-c and one SSB on the first sub-band 505-a and the second sub-band 505-b. A sub-band 505 configured with multiple SSBs 520 per occasion 515 may similarly cycle through SSB beams. For example, the network node 105 may transmit SSBs using the third SSB beam and a fourth SSB beam at the first occasion 515-a, and the network node 105 may transmit SSBs using the fourth SSB beam and the first SSB beam at the second occasion 515-b.

In some examples, an SSB 520 on one sub-band 505 may be a quasi co-location source for signaling on another sub-band 505. For example, the network node 105 may indicate whether the first SSB 520-a received via the first sub-band 505-a can be used as a quasi co-location source for a data channel, a control channel, or reference signals on the second sub-band 505-b. In some examples, the network node 105 that an SSB beam on one sub-band cannot be used as a quasi co-location source for channels or reference signals on another sub-band.

FIG. 6 shows an example of a joint scheduling configuration 600 that supports SSB transmission for flexible spectrum integration in accordance with one or more aspects of the present disclosure.

A network node 105 may configure a UE 115 with a virtual cell including one or more SBGs. Each SBG may include multiple sub-bands, or N sub-bands. For example, an SBG may include three sub-bands 605, including a first sub-band 605-a, a second sub-band 605-b, and a third sub-band 605-c. In other examples, SBGs may include different quantities of sub-bands. An aggregated bandwidth 610 of the SBG may span all bandwidths of the sub-bands 605 of the SBG.

In some examples, the network node 105 may periodically transmit an SSB burst. For example, the network node 105 may transmit an SSB burst with a periodicity of T. In some examples, T may correspond to a quantity of radio frames. For example, the periodicity may be one radio frame, and the network node 105 may transmit an SSB burst each radio frame. At a first occasion 615-a (e.g., T0 in FIG. 6), the network node 105 may transmit a first SSB burst, and the network node 105 may transmit a second SSB burst at a second occasion 615-b (e.g., T1 in FIG. 6). In some examples, the network node 105 may transmit a first SSB burst after a timing offset, T_{offset}. The timing offset may be from an activation of an SSB or SSB burst, a signal from the network node 105, a reference time, or any combination thereof.

In some examples, cell defining SSBs 620 and non-cell defining SSBs 625 may be jointly scheduled. For example, both cell defining SSBs 620 and non-cell defining SSBs 625 may be configured on an activated sub-band or active BWP of a virtual cell. Beam bitmaps, transmit powers (e.g., absolute powers or power boosting levels), time offsets, periodicities, or any combination thereof, may be separately configured for cell defining and non-cell defining SSB beams on the same sub-band or SBG.

In some examples, periodic cell defining SSBs may be transmitted on a wide-band sub-band, and non-cell defining SSBs may be dynamically configured for narrow-band sub-bands. For example, the network node 105 may transmit non-cell defining SSBs 625 via the first sub-band 605-a and the second sub-band 605-b, and the network node 105 may transmit cell defining SSBs 620 via the third sub-band 605-c. In some examples, the non-cell defining SSBs 625 may be dynamically configured. In some examples, the non-cell defining SSBs 625 may be transmitted on-demand. For example, a UE 115 may request transmission of the non-cell defining SSBs 625. Additionally, or alternatively, the network node 105 may determine that one or more UEs 115 are to perform measurements on a sub-band 605, and the network node 105 may configure non-cell defining SSBs 625 on the sub-band 605.

In some examples, a network node 105 may transmit periodic cell defining SSBs sparsely in time and space, and the network node 105 may dynamically transmit non-cell defining SSBs (e.g., dynamically transmitted on-demand in time, space, and frequency). For example, the network node 105 may transmit a first SSB burst of cell defining SSBs 620 at the first occasion 615-a. The network node 105 may transmit a first cell defining SSB 620-a using a first SSB beam, a second cell defining SSB 620-b using a second SSB beam, a third cell defining SSB 620-c using a third SSB beam, and a fourth cell defining SSB 620-d using a fourth SSB beam.

In some examples, an SSB burst of cell defining SSBs 620 may be periodic. For example, the network node 105 may transmit the SSB burst of cell defining SSBs 620 once per four occasions 615. At a fifth occasion 615-e, the network node 105 may transmit a second SSB burst of cell defining SSBs 620. Between the periods of the cell defining SSB burst (e.g., between the first occasion 615-a and the fifth occasion 615-e), the network node 105 may dynamically transmit non-cell defining SSBs 625. For example, the network node 105 may transmit a non-cell defining SSB 625-b using the second SSB beam via the first sub-band 605-a at the second occasion 615-b. The network node 105 may transmit a non-cell defining SSB 625-a using the first SSB beam and a non-cell defining SSB 625-d using the fourth SSB beam via the third sub-band 605-c at the second occasion 615-b, and the network node 105 may not transmit an SSB via the second sub-band 605-b during the second occasion 615-b. At a third occasion 615-c, the network node 105 may transmit a non-cell defining SSB 625-c using a third SSB beam via the first sub-band 605-a, and the network node 105 may not transmit any SSBs for the SBG via the third sub-band 605-c. Similarly, the network node 105 may transmit non-cell defining SSBs 625 during the fourth occasion 615-d.

In some examples, the joint scheduling configuration 600 may implement aspects of an intra-SBG frequency hopping configuration 300, an intra-SBG fixed beam sweeping configuration 400, an intra-SBG cyclical beam sweeping configuration 500, or any combination thereof. For example, cell defining SSBs 620 or non-cell defining SSBs 625, or both, may be configured for frequency hopping or beam sweeping across the sub-bands 605 of an SBG. In some examples, cell defining SSBs 620 and non-cell defining SSBs 625 may have respective configurations. For example, cell defining SSBs 620 may be frequency hopped as described herein, and non-cell defining SSBs 625 may be cyclically beam swept as described herein.

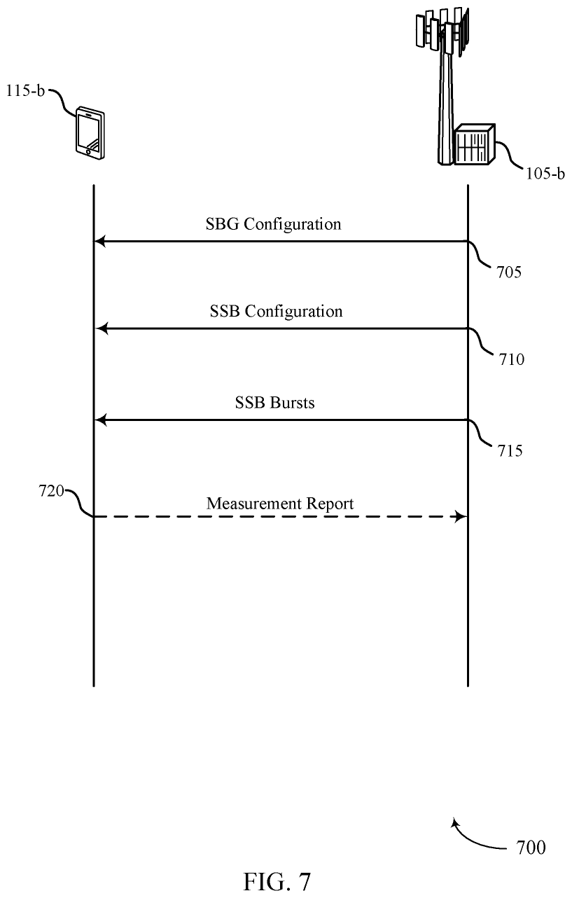

FIG. 7 shows an example of a process flow 700 that supports SSB transmission for flexible spectrum integration in accordance with one or more aspects of the present disclosure. The process flow 700 may implement aspects of a wireless communications system 100 or a wireless communications system 200. For example, the process flow 700 may illustrate operations between a UE 115-b and a network node 105-b, which may be respective examples of a UE 115 and a network node 105 described herein. In the following description of the process flow 700, some signaling between the UE 115-b and the network node 105-b may be transmitted in a different order than the example order shown, or the operations performed by the UE 115-b and the network node 105-b may be performed in different orders or at different times. Some operations also may be omitted from the process flow 700, or other operations may be added to the process flow 700.

At 705, the network node 105-b may transmit an SBG configuration to the UE 115-b. For example, the UE 115-b may receive a first control signal indicating a first configuration for an SBG including multiple sub-bands. In some examples, the SBG, or the multiple sub-bands, may be associated with a virtual cell configured for the UE 115-b.

At 710, the network node 105-b may transmit an SSB configuration to the UE 115-b. For example, the UE 115-b may receive a second control signal indicating a second configuration for multiple SSBs over the multiple sub-bands of the SBG. In some examples, each of the multiple SSBs may include a same cell identifier. For example, the SSBs may be configured for measurements of the virtual cell. Each SSB transmitted for the virtual cell or for measurement of the virtual cell may include a same cell identifier.

At 715, the network node 105-b may transmit an SSB burst in accordance with the SSB configuration. The UE 115-b may measure, via one or more sub-bands of the SBG, one or more SSBs of the multiple SSBs in accordance with at least one of the first configuration, the second configuration, or a combination of both.

The network node 105-b may transmit the SSB burst in accordance with an SSB transmission pattern, such as an intra-SBG frequency hopping configuration or an intra-SBG beam sweeping pattern. In some examples, the second control signal may indicate the SSB transmission pattern. In some other examples, separate signaling may indicate the SSB transmission pattern.

In some examples, the SSB transmission pattern may be based on an intra-SBG frequency hopping configuration. For example, the network node 105-b may transmit a first SSB burst via a first sub-band of the SBG during a first occasion in accordance with second configuration. The UE 115-b may measure the first SSB based on an active BWP of the UE 115-b including the first sub-band. The network node 105-b may transmit a second SSB burst via a second sub-band of the SBG during a second occasion. If the active BWP of the UE 115-b includes the second sub-band, the UE 115-b may measure the second SSB burst via the second sub-band of the SBG.

In some examples, the SSB transmission pattern may be based on an intra-SBG beam sweeping configuration. For example, the network node 105-b may transmit, via a first sub-band of the SBG using a first beam, a first SSB of an SSB burst during a first time interval in accordance with the second configuration, and the network node 105-b may transmit, via a second sub-band of the sub-bands of the SBG using a second beam, a second SSB of the SSB burst during the first time interval in accordance with the second configuration. The UE 115-b may receive, via the first sub-band, the first SSB during the first time interval in accordance with the second configuration. For example, other SSBs of the SSB burst may be transmitted via different sub-bands SBG, which may be indicated via the SBG beam sweeping configuration. The intra-SBG beam sweeping configuration may be a fixed beam sweeping configuration or a cyclical beam sweeping configuration.

In some examples, the UE 115-b may transmit a measurement report at 720. For example, the UE 115-b may transmit a measurement report based on measuring the one or more SSBs. In some examples, the UE 115-b may have received SSBs across multiple sub-bands. The UE 115-b may average measurements made via the multiple sub-bands, and the measurement report may indicate the average measurements.

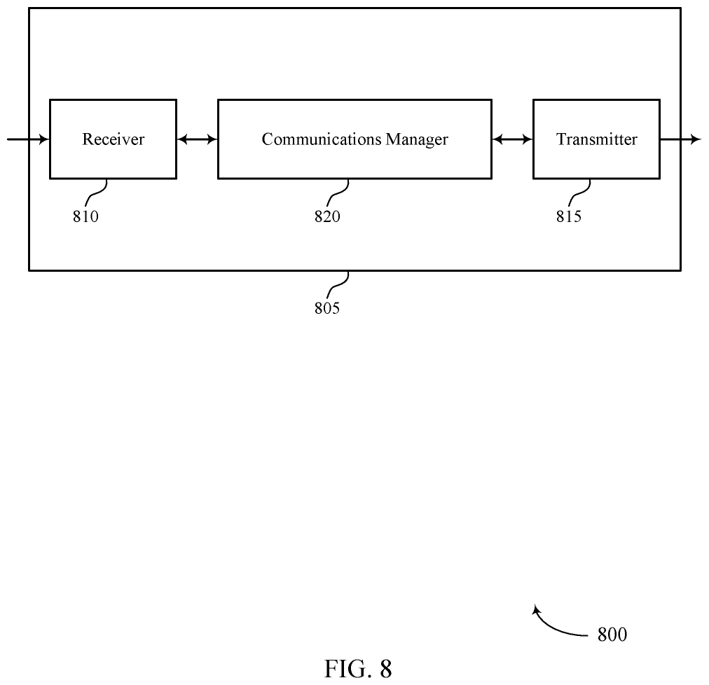

FIG. 8 shows a block diagram 800 of a device 805 that supports SSB transmission for flexible spectrum integration in accordance with one or more aspects of the present disclosure. The device 805 may be an example of aspects of a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to SSB transmission for flexible spectrum integration). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to SSB transmission for flexible spectrum integration). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations or components thereof may be examples of means for performing various aspects of SSB transmission for flexible spectrum integration as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for receiving a first control signal indicating a first configuration for a SBG including a set of multiple sub-bands. The communications manager 820 is capable of, configured to, or operable to support a means for receiving a second control signal indicating a second configuration for a set of multiple SSBs over the set of multiple sub-bands of the SBG, each of the set of multiple SSBs including a same cell identifier. The communications manager 820 is capable of, configured to, or operable to support a means for measuring, via one or more sub-bands of the SBG, one or more SSBs of the set of multiple SSBs in accordance with at least one of the first configuration, the second configuration, or a combination thereof.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for more efficient utilization of communication resources.

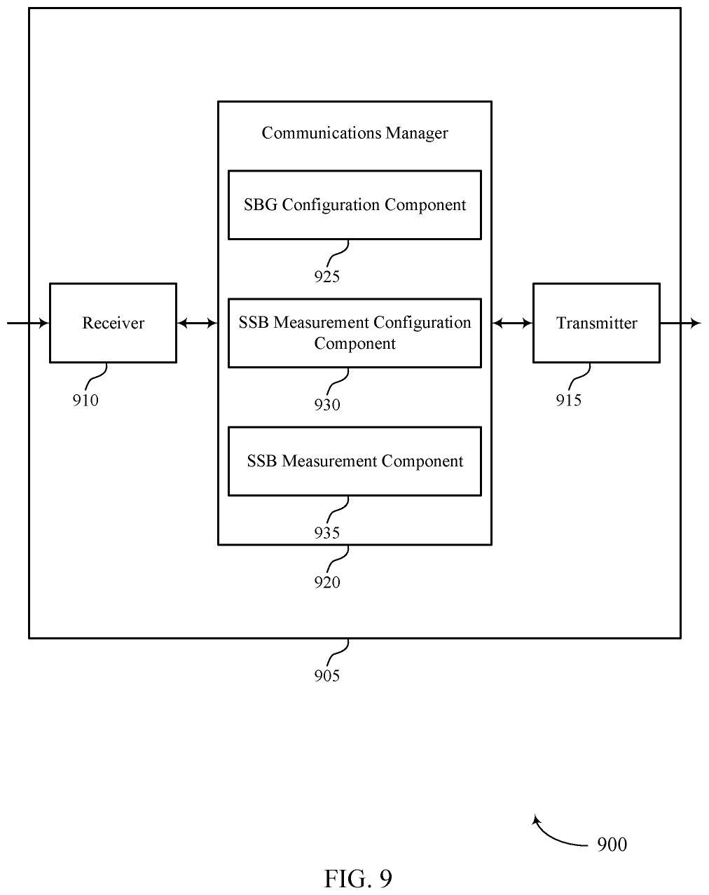

FIG. 9 shows a block diagram 900 of a device 905 that supports SSB transmission for flexible spectrum integration in accordance with one or more aspects of the present disclosure. The device 905 may be an example of aspects of a device 805 or a UE 115 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to SSB transmission for flexible spectrum integration). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to SSB transmission for flexible spectrum integration). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of SSB transmission for flexible spectrum integration as described herein. For example, the communications manager 920 may include an SBG configuration component 925, an SSB measurement configuration component 930, an SSB measurement component 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The SBG configuration component 925 is capable of, configured to, or operable to support a means for receiving a first control signal indicating a first configuration for a SBG including a set of multiple sub-bands. The SSB measurement configuration component 930 is capable of, configured to, or operable to support a means for receiving a second control signal indicating a second configuration for a set of multiple SSBs over the set of multiple sub-bands of the SBG, each of the set of multiple SSBs including a same cell identifier. The SSB measurement component 935 is capable of, configured to, or operable to support a means for measuring, via one or more sub-bands of the SBG, one or more SSBs of the set of multiple SSBs in accordance with at least one of the first configuration, the second configuration, or a combination thereof.

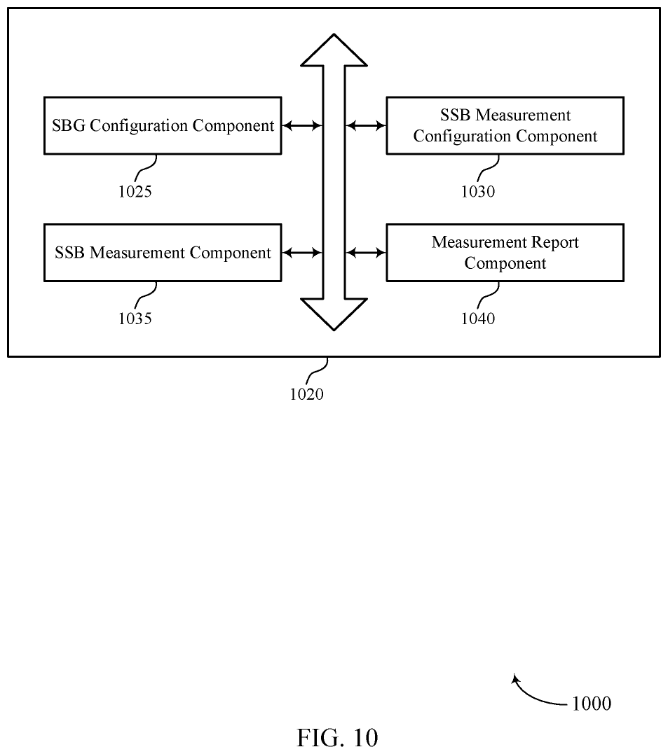

FIG. 10 shows a block diagram 1000 of a communications manager 1020 that supports SSB transmission for flexible spectrum integration in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of SSB transmission for flexible spectrum integration as described herein. For example, the communications manager 1020 may include an SBG configuration component 1025, an SSB measurement configuration component 1030, an SSB measurement component 1035, a measurement report component 1040, or any combination thereof. Each of these components, or components or subcomponents thereof (e.g., one or more processors, one or more memories), may communicate, directly or indirectly, with one another (e.g., via one or more buses).

The communications manager 1020 may support wireless communications in accordance with examples as disclosed herein. The SBG configuration component 1025 is capable of, configured to, or operable to support a means for receiving a first control signal indicating a first configuration for a SBG including a set of multiple sub-bands. The SSB measurement configuration component 1030 is capable of, configured to, or operable to support a means for receiving a second control signal indicating a second configuration for a set of multiple SSBs over the set of multiple sub-bands of the SBG, each of the set of multiple SSBs including a same cell identifier. The SSB measurement component 1035 is capable of, configured to, or operable to support a means for measuring, via one or more sub-bands of the SBG, one or more SSBs of the set of multiple SSBs in accordance with at least one of the first configuration, the second configuration, or a combination thereof.

In some examples, the second control signal indicates a frequency hopping pattern for the set of multiple SSBs. In some examples, a first SSB burst is associated with a first sub-band of the set of multiple sub-bands during a first time interval, and a second SSB burst is associated with a second sub-band of the set of multiple sub-bands during a second time interval in accordance with the frequency hopping pattern.

In some examples, to support measuring the one or more SSBs, the SSB measurement component 1035 is capable of, configured to, or operable to support a means for receiving a first SSB burst via a first sub-band of the set of multiple sub-bands in accordance with the second configuration, where the first sub-band is within an active bandwidth part of the UE.

In some examples, the SSB measurement component 1035 is capable of, configured to, or operable to support a means for receiving a second SSB burst via a second sub-band of the set of multiple sub-bands, where the second sub-band is within the active bandwidth part of the UE.

In some examples, a periodicity of an SSB burst associated with a sub-band of the SBG is based on a quantity of the set of multiple sub-bands in the SBG.

In some examples, the second control signal indicates a beam sweeping pattern for the set of multiple SSBs across the set of multiple sub-bands. In some examples, a first SSB of an SSB burst is associated with a first sub-band of the set of multiple sub-bands. In some examples, a second SSB of the SSB burst is associated with a second sub-band of the set of multiple sub-bands.

In some examples, the second control signal indicates a first bitmap that maps at least the first SSB to the first sub-band and a second bitmap that maps at least the second SSB to the second sub-band.

In some examples, a quantity of SSBs associated with the first sub-band is based on a bandwidth size of the first sub-band.

In some examples, the SSB measurement component 1035 is capable of, configured to, or operable to support a means for receiving, via a first sub-band of the set of multiple sub-bands, a first SSB of an SSB burst during a first time interval in accordance with the second configuration, where remaining SSBs of the SSB burst are associated with different sub-bands of the set of multiple sub-bands. In some examples, the SSB measurement component 1035 is capable of, configured to, or operable to support a means for receiving, via the first sub-band, the first SSB during a second time interval in accordance with the second configuration.

In some examples, the second control signal indicates a cyclic beam sweeping pattern for the set of multiple SSBs across the set of multiple sub-bands and a set of multiple intervals.

In some examples, to support measuring the one or more SSBs, the SSB measurement component 1035 is capable of, configured to, or operable to support a means for receiving, via a first sub-band of the set of multiple sub-bands, a first SSB of an SSB burst during a first time interval in accordance with the second configuration. In some examples, to support measuring the one or more SSBs, the SSB measurement component 1035 is capable of, configured to, or operable to support a means for receiving, via the first sub-band, a second SSB of the SSB burst in accordance with the second configuration.

In some examples, the SBG configuration component 1025 is capable of, configured to, or operable to support a means for receiving an indication that SSBs received via a first sub-band are quasi co-located with a data channel, a control channel, or a reference signal, or any combination thereof, on a second sub-band.

In some examples, the second control signal indicates one or more beam bitmaps, one or more transmit powers, one or more time offsets, or one or more periodicities, or any combination thereof, for the set of multiple SSBs.

In some examples, the second control signal indicates a first set of parameters for cell defining SSBs and a second set of parameters for non-cell defining SSBs.

In some examples, a first sub-band of the set of multiple sub-bands is associated with non-cell defining SSBs, and a second sub-band of the set of multiple sub-bands is associated with cell defining SSBs.

In some examples, the one or more SSBs include one or more cell defining SSBs or one or more non-cell defining SSBs, or both.

In some examples, the measurement report component 1040 is capable of, configured to, or operable to support a means for transmitting a measurement report based on measuring the one or more SSBs.

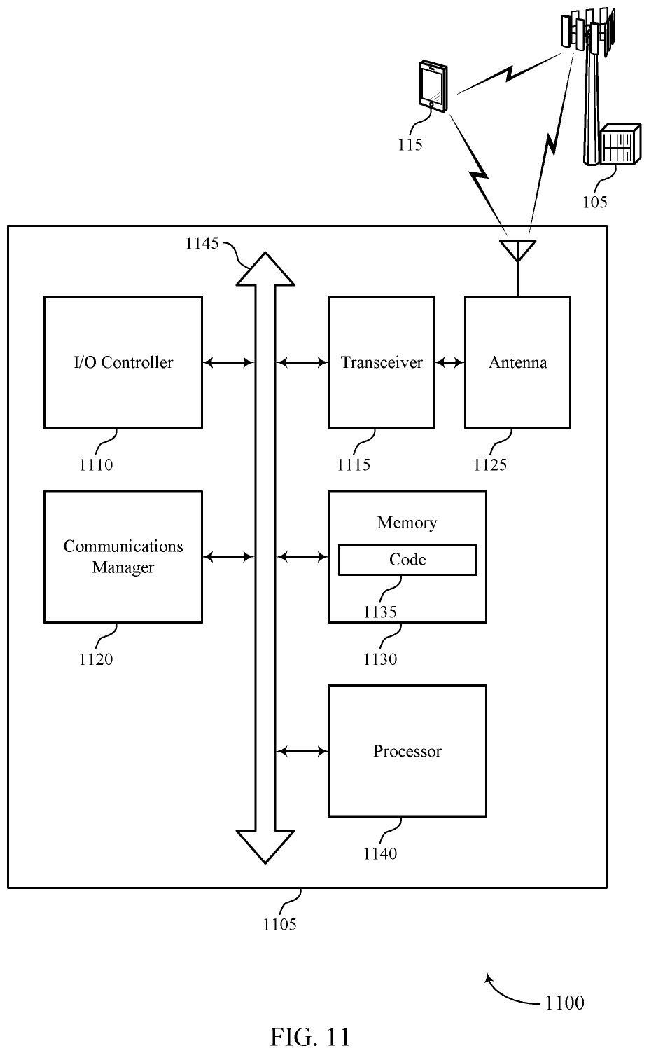

FIG. 11 shows a diagram of a system 1100 including a device 1105 that supports SSB transmission for flexible spectrum integration in accordance with one or more aspects of the present disclosure. The device 1105 may be an example of or include components of a device 805, a device 905, or a UE 115 as described herein. The device 1105 may communicate (e.g., wirelessly) with one or more other devices (e.g., network nodes 105, UEs 115, or a combination thereof). The device 1105 may include components for bi-directional voice and data communications including components for transmitting and receiving communications, such as a communications manager 1120, an input/output (I/O) controller, such as an I/O controller 1110, a transceiver 1115, one or more antennas 1125, at least one memory 1130, code 1135, and at least one processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of one or more processors, such as the at least one processor 1140. In some cases, a user may interact with the device 1105 via the I/O controller 1110 or via hardware components controlled by the I/O controller 1110.

In some cases, the device 1105 may include a single antenna. However, in some other cases, the device 1105 may have more than one antenna, which may be capable of concurrently transmitting or receiving multiple wireless transmissions. The transceiver 1115 may communicate bi-directionally via the one or more antennas 1125 using wired or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The at least one memory 1130 may include random access memory (RAM) and read-only memory (ROM). The at least one memory 1130 may store computer-readable, computer-executable, or processor-executable code, such as the code 1135. The code 1135 may include instructions that, when executed by the at least one processor 1140, cause the device 1105 to perform various functions described herein. The code 1135 may be stored in a non-transitory computer-readable medium such as system memory or another type of memory. In some cases, the code 1135 may not be directly executable by the at least one processor 1140 but may cause a computer (e.g., when compiled and executed) to perform functions described herein. In some cases, the at least one memory 1130 may include, among other things, a basic I/O system (BIOS) which may control basic hardware or software operation such as the interaction with peripheral components or devices.

The at least one processor 1140 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1140 may be configured to operate a memory array using a memory controller. In some other cases, a memory controller may be integrated into the at least one processor 1140. The at least one processor 1140 may be configured to execute computer-readable instructions stored in a memory (e.g., the at least one memory 1130) to cause the device 1105 to perform various functions (e.g., functions or tasks supporting SSB transmission for flexible spectrum integration). For example, the device 1105 or a component of the device 1105 may include at least one processor 1140 and at least one memory 1130 coupled with or to the at least one processor 1140, the at least one processor 1140 and the at least one memory 1130 configured to perform various functions described herein.

In some examples, the at least one processor 1140 may include multiple processors and the at least one memory 1130 may include multiple memories. One or more of the multiple processors may be coupled with one or more of the multiple memories, which may, individually or collectively, be configured to perform various functions described herein. In some examples, the at least one processor 1140 may be a component of a processing system, which may refer to a system (such as a series) of machines, circuitry (including, for example, one or both of processor circuitry (which may include the at least one processor 1140) and memory circuitry (which may include the at least one memory 1130)), or components, that receives or obtains inputs and processes the inputs to produce, generate, or obtain a set of outputs. The processing system may be configured to perform one or more of the functions described herein. For example, the at least one processor 1140 or a processing system including the at least one processor 1140 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code 1135 (e.g., processor-executable code) stored in the at least one memory 1130 or otherwise, to perform one or more of the functions described herein.

The communications manager 1120 may support wireless communications in accordance with examples as disclosed herein. For example, the communications manager 1120 is capable of, configured to, or operable to support a means for receiving a first control signal indicating a first configuration for a SBG including a set of multiple sub-bands. The communications manager 1120 is capable of, configured to, or operable to support a means for receiving a second control signal indicating a second configuration for a set of multiple SSBs over the set of multiple sub-bands of the SBG, each of the set of multiple SSBs including a same cell identifier. The communications manager 1120 is capable of, configured to, or operable to support a means for measuring, via one or more sub-bands of the SBG, one or more SSBs of the set of multiple SSBs in accordance with at least one of the first configuration, the second configuration, or a combination thereof.

By including or configuring the communications manager 1120 in accordance with examples as described herein, the device 1105 may support techniques for improved communication reliability and more efficient utilization of communication resources.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the at least one processor 1140, the at least one memory 1130, the code 1135, or any combination thereof. For example, the code 1135 may include instructions executable by the at least one processor 1140 to cause the device 1105 to perform various aspects of SSB transmission for flexible spectrum integration as described herein, or the at least one processor 1140 and the at least one memory 1130 may be otherwise configured to, individually or collectively, perform or support such operations.

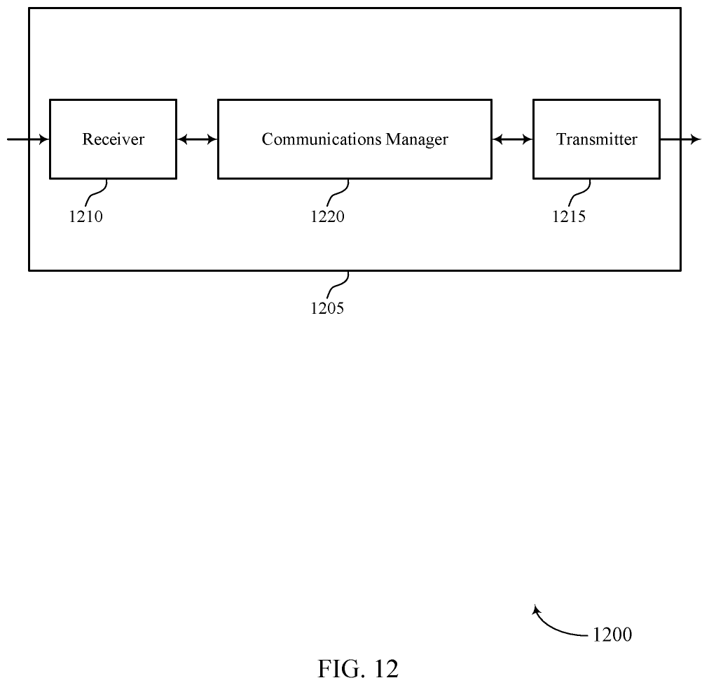

FIG. 12 shows a block diagram 1200 of a device 1205 that supports SSB transmission for flexible spectrum integration in accordance with one or more aspects of the present disclosure. The device 1205 may be an example of aspects of a network node 105 as described herein. The device 1205 may include a receiver 1210, a transmitter 1215, and a communications manager 1220. The device 1205, or one or more components of the device 1205 (e.g., the receiver 1210, the transmitter 1215, the communications manager 1220), may include at least one processor, which may be coupled with at least one memory, to, individually or collectively, support or enable the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The communications manager 1220, the receiver 1210, the transmitter 1215, or various combinations or components thereof may be examples of means for performing various aspects of SSB transmission for flexible spectrum integration as described herein. For example, the communications manager 1220, the receiver 1210, the transmitter 1215, or various combinations or components thereof may be capable of performing one or more of the functions described herein.

In some examples, the communications manager 1220, the receiver 1210, the transmitter 1215, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1220, the receiver 1210, the transmitter 1215, or various combinations or components thereof may be implemented in code (e.g., as communications management software or firmware) executed by at least one processor (e.g., referred to as a processor-executable code). If implemented in code executed by at least one processor, the functions of the communications manager 1220, the receiver 1210, the transmitter 1215, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1220 may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. For example, the communications manager 1220 is capable of, configured to, or operable to support a means for transmitting a first control signal indicating a first configuration for a SBG including a set of multiple sub-bands. The communications manager 1220 is capable of, configured to, or operable to support a means for transmitting a second control signal indicating a second configuration for a set of multiple SSBs over the set of multiple sub-bands of the SBG, each of the set of multiple SSBs including a same cell identifier. The communications manager 1220 is capable of, configured to, or operable to support a means for transmitting, over the set of multiple sub-bands of the SBG, the set of multiple SSBs in accordance with at least one of the first configuration, the second configuration, or a combination thereof.

By including or configuring the communications manager 1220 in accordance with examples as described herein, the device 1205 (e.g., at least one processor controlling or otherwise coupled with the receiver 1210, the transmitter 1215, the communications manager 1220, or a combination thereof) may support techniques for reduced power consumption and more efficient utilization of communication resources.

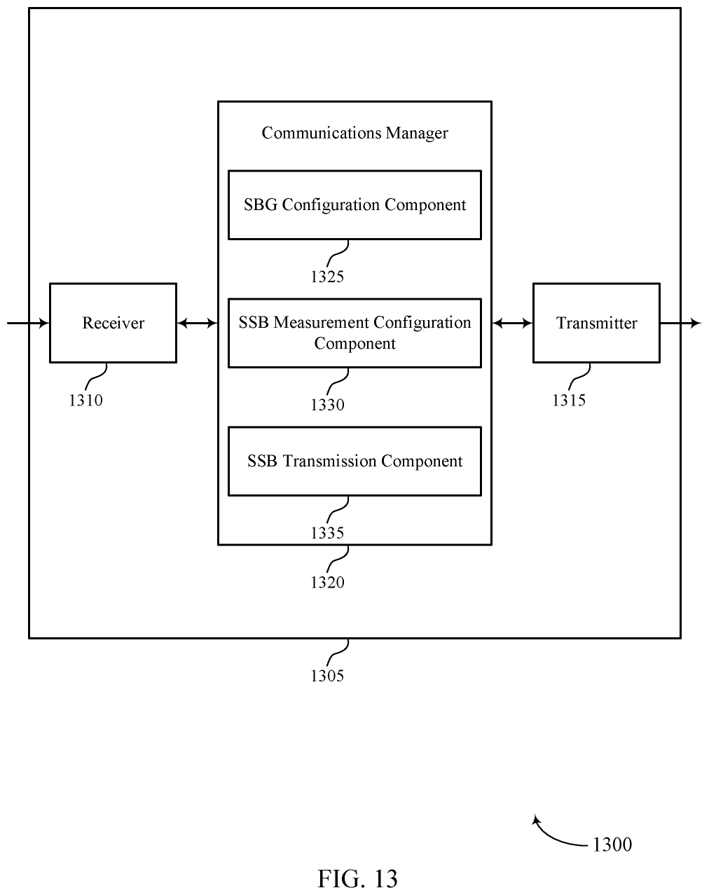

FIG. 13 shows a block diagram 1300 of a device 1305 that supports SSB transmission for flexible spectrum integration in accordance with one or more aspects of the present disclosure. The device 1305 may be an example of aspects of a device 1205 or a network node 105 as described herein. The device 1305 may include a receiver 1310, a transmitter 1315, and a communications manager 1320. The device 1305, or one or more components of the device 1305 (e.g., the receiver 1310, the transmitter 1315, the communications manager 1320), may include at least one processor, which may be coupled with at least one memory, to support the described techniques. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The device 1305, or various components thereof, may be an example of means for performing various aspects of SSB transmission for flexible spectrum integration as described herein. For example, the communications manager 1320 may include an SBG configuration component 1325, an SSB measurement configuration component 1330, an SSB transmission component 1335, or any combination thereof. The communications manager 1320 may be an example of aspects of a communications manager 1220 as described herein. In some examples, the communications manager 1320, or various components thereof, may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communications in accordance with examples as disclosed herein. The SBG configuration component 1325 is capable of, configured to, or operable to support a means for transmitting a first control signal indicating a first configuration for a SBG including a set of multiple sub-bands. The SSB measurement configuration component 1330 is capable of, configured to, or operable to support a means for transmitting a second control signal indicating a second configuration for a set of multiple SSBs over the set of multiple sub-bands of the SBG, each of the set of multiple SSBs including a same cell identifier. The SSB transmission component 1335 is capable of, configured to, or operable to support a means for transmitting, over the set of multiple sub-bands of the SBG, the set of multiple SSBs in accordance with at least one of the first configuration, the second configuration, or a combination thereof.

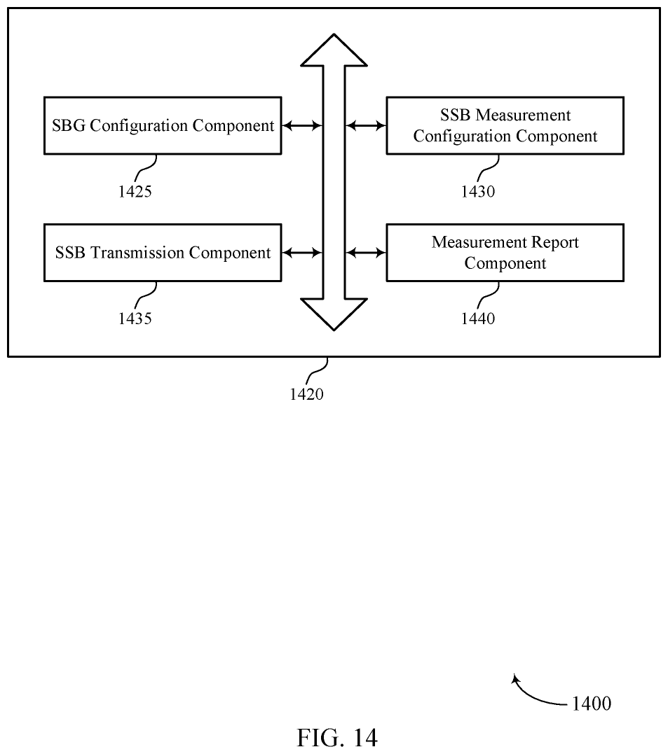

FIG. 14 shows a block diagram 1400 of a communications manager 1420 that supports SSB transmission for flexible spectrum integration in accordance with one or more aspects of the present disclosure. The communications manager 1420 may be an example of aspects of a communications manager 1220, a communications manager 1320, or both, as described herein. The communications manager 1420, or various components thereof, may be an example of means for performing various aspects of SSB transmission for flexible spectrum integration as described herein. For example, the communications manager 1420 may include an SBG configuration component 1425, an SSB measurement configuration component 1430, an SSB transmission component 1435, a measurement report component 1440, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network node 105, between devices, components, or virtualized components associated with a network node 105), or any combination thereof.

The communications manager 1420 may support wireless communications in accordance with examples as disclosed herein. The SBG configuration component 1425 is capable of, configured to, or operable to support a means for transmitting a first control signal indicating a first configuration for a SBG including a set of multiple sub-bands. The SSB measurement configuration component 1430 is capable of, configured to, or operable to support a means for transmitting a second control signal indicating a second configuration for a set of multiple SSBs over the set of multiple sub-bands of the SBG, each of the set of multiple SSBs including a same cell identifier. The SSB transmission component 1435 is capable of, configured to, or operable to support a means for transmitting, over the set of multiple sub-bands of the SBG, the set of multiple SSBs in accordance with at least one of the first configuration, the second configuration, or a combination thereof.

In some examples, the second control signal indicates a frequency hopping pattern for the set of multiple SSBs. In some examples, a first SSB burst is associated with a first sub-band of the set of multiple sub-bands during a first time interval, and a second SSB burst is associated with a second sub-band of the set of multiple sub-bands during a second time interval in accordance with the frequency hopping pattern.

In some examples, to support measuring the one or more SSBs, the SSB transmission component 1435 is capable of, configured to, or operable to support a means for transmitting a first SSB burst via a first sub-band of the set of multiple sub-bands during a first occasion in accordance with the second configuration; and. In some examples, to support measuring the one or more SSBs, the SSB transmission component 1435 is capable of, configured to, or operable to support a means for transmitting a second SSB burst via a second sub-band of the set of multiple sub-bands during a second occasion in accordance with the second configuration.

In some examples, a periodicity of an SSB burst associated with a sub-band of the SBG is based on a quantity of the set of multiple sub-bands in the SBG.

In some examples, the second control signal indicates a beam sweeping pattern for the set of multiple SSBs across the set of multiple sub-bands. In some examples, a first SSB of an SSB burst is associated with a first sub-band of the set of multiple sub-bands. In some examples, a second SSB of the SSB burst is associated with a second sub-band of the set of multiple sub-bands.

In some examples, the second control signal indicates a first bitmap that maps at least the first SSB to the first sub-band and a second bitmap that maps at least the second SSB to the second sub-band.

In some examples, a quantity of SSBs associated with the first sub-band is based on a bandwidth size of the first sub-band.

In some examples, the SSB transmission component 1435 is capable of, configured to, or operable to support a means for transmitting, via a first sub-band of the set of multiple sub-bands using a first beam, a first SSB of an SSB burst during a first time interval in accordance with the second configuration. In some examples, the SSB transmission component 1435 is capable of, configured to, or operable to support a means for transmitting, via a second sub-band of the set of multiple sub-bands using a second beam, a second SSB of the SSB burst during the first time interval in accordance with the second configuration.

In some examples, the SSB transmission component 1435 is capable of, configured to, or operable to support a means for transmitting, via the first sub-band of the set of multiple sub-bands using the first beam, a third SSB of a second SSB burst during a second time interval in accordance with the second configuration.

In some examples, the SSB transmission component 1435 is capable of, configured to, or operable to support a means for transmitting, via the first sub-band of the set of multiple sub-bands using the second beam, a third SSB of a second SSB burst during a second time interval in accordance with the second configuration.

In some examples, the second control signal indicates a cyclic beam sweeping pattern for the set of multiple SSBs across the set of multiple sub-bands and a set of multiple intervals.

In some examples, the SBG configuration component 1425 is capable of, configured to, or operable to support a means for transmitting an indication that SSBs transmitted via a first sub-band are quasi co-located with a data channel, a control channel, or a reference signal, or any combination thereof, on a second sub-band.

In some examples, the measurement report component 1440 is capable of, configured to, or operable to support a means for receiving a measurement report based on one or more SSBs of the set of multiple SSBs.

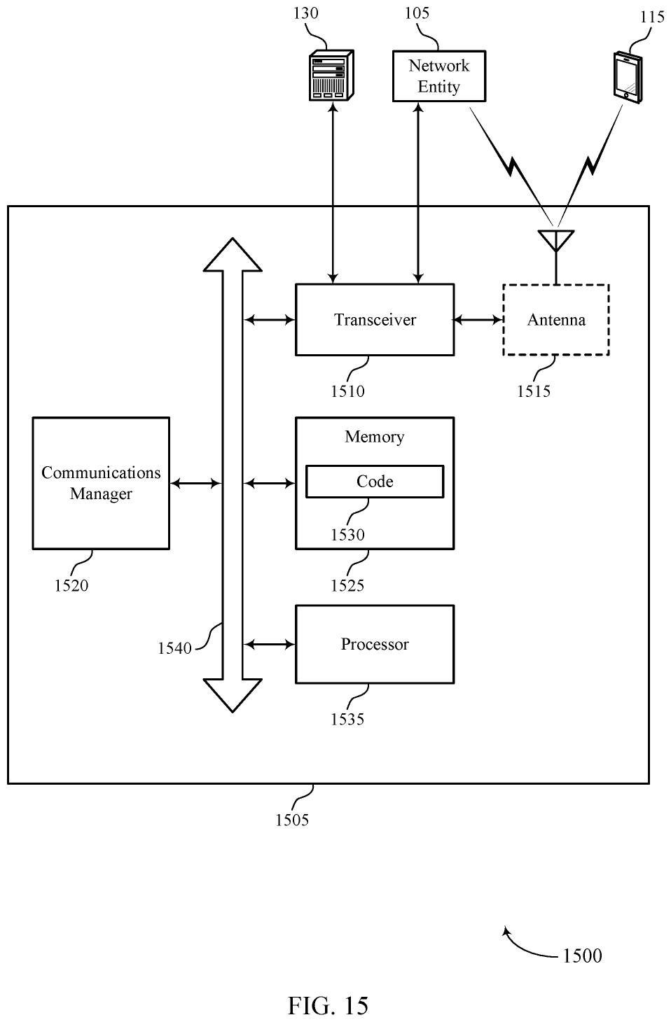

FIG. 15 shows a diagram of a system 1500 including a device 1505 that supports SSB transmission for flexible spectrum integration in accordance with one or more aspects of the present disclosure. The device 1505 may be an example of or include components of a device 1205, a device 1305, or a network node 105 as described herein. The device 1505 may communicate with other network devices or network equipment such as one or more of the network nodes 105, UEs 115, or any combination thereof. The communications may include communications over one or more wired interfaces, over one or more wireless interfaces, or any combination thereof. The device 1505 may include components that support outputting and obtaining communications, such as a communications manager 1520, a transceiver 1510, one or more antennas 1515, at least one memory 1525, code 1530, and at least one processor 1535. These components may be in electronic communication or otherwise coupled (e.g., operatively, communicatively, functionally, electronically, electrically) via one or more buses (e.g., a bus 1540).

The transceiver 1510 may support bi-directional communications via wired links, wireless links, or both as described herein. In some examples, the transceiver 1510 may include a wired transceiver and may communicate bi-directionally with another wired transceiver. Additionally, or alternatively, in some examples, the transceiver 1510 may include a wireless transceiver and may communicate bi-directionally with another wireless transceiver. In some examples, the device 1505 may include one or more antennas 1515, which may be capable of transmitting or receiving wireless transmissions (e.g., concurrently). The transceiver 1510 may also include a modem to modulate signals, to provide the modulated signals for transmission (e.g., by one or more antennas 1515, by a wired transmitter), to receive modulated signals (e.g., from one or more antennas 1515, from a wired receiver), and to demodulate signals. In some implementations, the transceiver 1510 may include one or more interfaces, such as one or more interfaces coupled with the one or more antennas 1515 that are configured to support various receiving or obtaining operations, or one or more interfaces coupled with the one or more antennas 1515 that are configured to support various transmitting or outputting operations, or a combination thereof. In some implementations, the transceiver 1510 may include or be configured for coupling with one or more processors or one or more memory components that are operable to perform or support operations based on received or obtained information or signals, or to generate information or other signals for transmission or other outputting, or any combination thereof. In some implementations, the transceiver 1510, or the transceiver 1510 and the one or more antennas 1515, or the transceiver 1510 and the one or more antennas 1515 and one or more processors or one or more memory components (e.g., the at least one processor 1535, the at least one memory 1525, or both), may be included in a chip or chip assembly that is installed in the device 1505. In some examples, the transceiver 1510 may be operable to support communications via one or more communications links (e.g., communication link(s) 125, backhaul communication link(s) 120, a midhaul communication link 162, a fronthaul communication link 168).

The at least one memory 1525 may include RAM, ROM, or any combination thereof. The at least one memory 1525 may store computer-readable, computer-executable, or processor-executable code, such as the code 1530. The code 1530 may include instructions that, when executed by one or more of the at least one processor 1535, cause the device 1505 to perform various functions described herein. The code 1530 may be stored in a non-transitory computer-readable medium such as system memory or another type of memory. In some cases, the code 1530 may not be directly executable by a processor of the at least one processor 1535 but may cause a computer (e.g., when compiled and executed) to perform functions described herein. In some cases, the at least one memory 1525 may include, among other things, a BIOS which may control basic hardware or software operation such as the interaction with peripheral components or devices. In some examples, the at least one processor 1535 may include multiple processors and the at least one memory 1525 may include multiple memories. One or more of the multiple processors may be coupled with one or more of the multiple memories which may, individually or collectively, be configured to perform various functions herein (for example, as part of a processing system).

The at least one processor 1535 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1535 may be configured to operate a memory array using a memory controller. In some other cases, a memory controller may be integrated into one or more of the at least one processor 1535. The at least one processor 1535 may be configured to execute computer-readable instructions stored in a memory (e.g., one or more of the at least one memory 1525) to cause the device 1505 to perform various functions (e.g., functions or tasks supporting SSB transmission for flexible spectrum integration). For example, the device 1505 or a component of the device 1505 may include at least one processor 1535 and at least one memory 1525 coupled with one or more of the at least one processor 1535, the at least one processor 1535 and the at least one memory 1525 configured to perform various functions described herein. The at least one processor 1535 may be an example of a cloud-computing platform (e.g., one or more physical nodes and supporting software such as operating systems, virtual machines, or container instances) that may host the functions (e.g., by executing code 1530) to perform the functions of the device 1505. The at least one processor 1535 may be any one or more suitable processors capable of executing scripts or instructions of one or more software programs stored in the device 1505 (such as within one or more of the at least one memory 1525).

In some examples, the at least one processor 1535 may include multiple processors and the at least one memory 1525 may include multiple memories. One or more of the multiple processors may be coupled with one or more of the multiple memories, which may, individually or collectively, be configured to perform various functions herein. In some examples, the at least one processor 1535 may be a component of a processing system, which may refer to a system (such as a series) of machines, circuitry (including, for example, one or both of processor circuitry (which may include the at least one processor 1535) and memory circuitry (which may include the at least one memory 1525)), or components, that receives or obtains inputs and processes the inputs to produce, generate, or obtain a set of outputs. The processing system may be configured to perform one or more of the functions described herein. For example, the at least one processor 1535 or a processing system including the at least one processor 1535 may be configured to, configurable to, or operable to cause the device 1505 to perform one or more of the functions described herein. Further, as described herein, being “configured to,” being “configurable to,” and being “operable to” may be used interchangeably and may be associated with a capability, when executing code stored in the at least one memory 1525 or otherwise, to perform one or more of the functions described herein.

In some examples, a bus 1540 may support communications of (e.g., within) a protocol layer of a protocol stack. In some examples, a bus 1540 may support communications associated with a logical channel of a protocol stack (e.g., between protocol layers of a protocol stack), which may include communications performed within a component of the device 1505, or between different components of the device 1505 that may be co-located or located in different locations (e.g., where the device 1505 may refer to a system in which one or more of the communications manager 1520, the transceiver 1510, the at least one memory 1525, the code 1530, and the at least one processor 1535 may be located in one of the different components or divided between different components).

In some examples, the communications manager 1520 may manage aspects of communications with a core network 130 (e.g., via one or more wired or wireless backhaul links). For example, the communications manager 1520 may manage the transfer of data communications for client devices, such as one or more UEs 115. In some examples, the communications manager 1520 may manage communications with one or more other network nodes 105, and may include a controller or scheduler for controlling communications with UEs 115 (e.g., in cooperation with the one or more other network devices). In some examples, the communications manager 1520 may support an X2 interface within an LTE/LTE-A wireless communications network technology to provide communication between network nodes 105.

The communications manager 1520 may support wireless communications in accordance with examples as disclosed herein. For example, the communications manager 1520 is capable of, configured to, or operable to support a means for transmitting a first control signal indicating a first configuration for a SBG including a set of multiple sub-bands. The communications manager 1520 is capable of, configured to, or operable to support a means for transmitting a second control signal indicating a second configuration for a set of multiple SSBs over the set of multiple sub-bands of the SBG, each of the set of multiple SSBs including a same cell identifier. The communications manager 1520 is capable of, configured to, or operable to support a means for transmitting, over the set of multiple sub-bands of the SBG, the set of multiple SSBs in accordance with at least one of the first configuration, the second configuration, or a combination thereof.

By including or configuring the communications manager 1520 in accordance with examples as described herein, the device 1505 may support techniques for improved communication reliability, reduced power consumption, and more efficient utilization of communication resources.

In some examples, the communications manager 1520 may be configured to perform various operations (e.g., receiving, obtaining, monitoring, outputting, transmitting) using or otherwise in cooperation with the transceiver 1510, the one or more antennas 1515 (e.g., where applicable), or any combination thereof. Although the communications manager 1520 is illustrated as a separate component, in some examples, one or more functions described with reference to the communications manager 1520 may be supported by or performed by the transceiver 1510, one or more of the at least one processor 1535, one or more of the at least one memory 1525, the code 1530, or any combination thereof (for example, by a processing system including at least a portion of the at least one processor 1535, the at least one memory 1525, the code 1530, or any combination thereof). For example, the code 1530 may include instructions executable by one or more of the at least one processor 1535 to cause the device 1505 to perform various aspects of SSB transmission for flexible spectrum integration as described herein, or the at least one processor 1535 and the at least one memory 1525 may be otherwise configured to, individually or collectively, perform or support such operations.

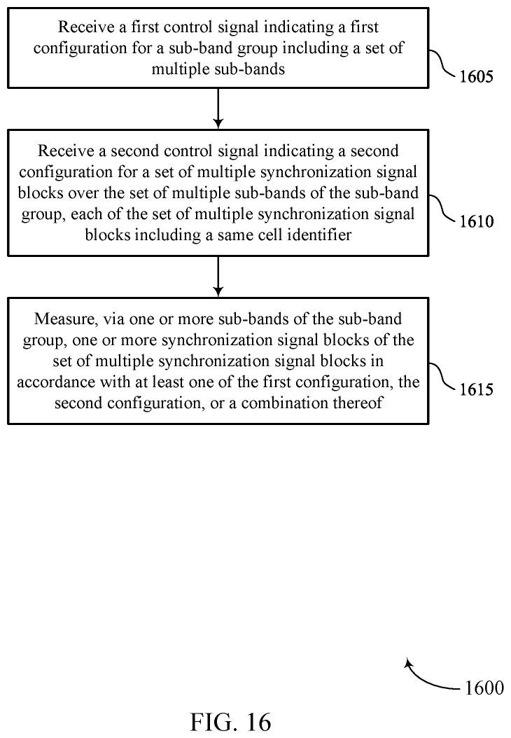

FIG. 16 shows a flowchart illustrating a method 1600 that supports SSB transmission for flexible spectrum integration in accordance with one or more aspects of the present disclosure. The operations of the method 1600 may be implemented by a UE or its components as described herein. For example, the operations of the method 1600 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1605, the method may include receiving a first control signal indicating a first configuration for a SBG including a set of multiple sub-bands. The operations of 1605 may be performed in accordance with examples as disclosed herein. In some examples, aspects of the operations of 1605 may be performed by an SBG configuration component 1025 as described with reference to FIG. 10.

At 1610, the method may include receiving a second control signal indicating a second configuration for a set of multiple SSBs over the set of multiple sub-bands of the SBG, each of the set of multiple SSBs including a same cell identifier. The operations of 1610 may be performed in accordance with examples as disclosed herein. In some examples, aspects of the operations of 1610 may be performed by an SSB measurement configuration component 1030 as described with reference to FIG. 10.

At 1615, the method may include measuring, via one or more sub-bands of the SBG, one or more SSBs of the set of multiple SSBs in accordance with at least one of the first configuration, the second configuration, or a combination thereof. The operations of 1615 may be performed in accordance with examples as disclosed herein. In some examples, aspects of the operations of 1615 may be performed by an SSB measurement component 1035 as described with reference to FIG. 10.

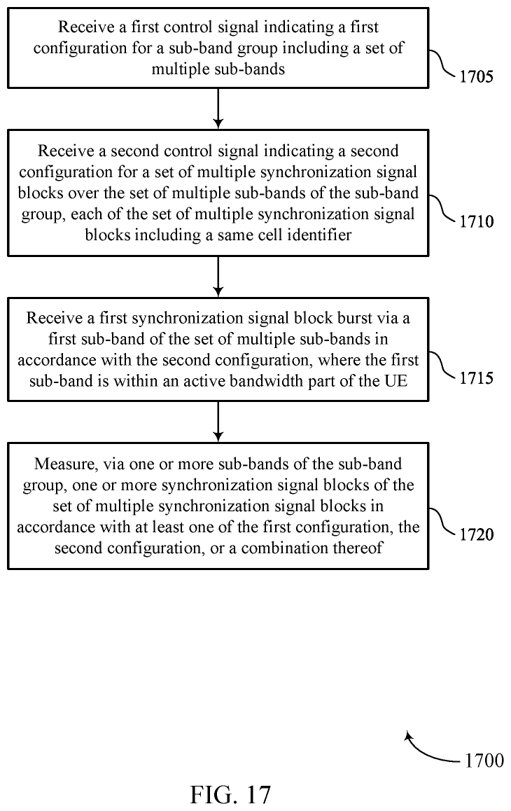

FIG. 17 shows a flowchart illustrating a method 1700 that supports SSB transmission for flexible spectrum integration in accordance with one or more aspects of the present disclosure. The operations of the method 1700 may be implemented by a UE or its components as described herein. For example, the operations of the method 1700 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1705, the method may include receiving a first control signal indicating a first configuration for a SBG including a set of multiple sub-bands. The operations of 1705 may be performed in accordance with examples as disclosed herein. In some examples, aspects of the operations of 1705 may be performed by an SBG configuration component 1025 as described with reference to FIG. 10.

At 1710, the method may include receiving a second control signal indicating a second configuration for a set of multiple SSBs over the set of multiple sub-bands of the SBG, each of the set of multiple SSBs including a same cell identifier. The operations of 1710 may be performed in accordance with examples as disclosed herein. In some examples, aspects of the operations of 1710 may be performed by an SSB measurement configuration component 1030 as described with reference to FIG. 10.

At 1715, the method may include receiving a first SSB burst via a first sub-band of the set of multiple sub-bands in accordance with the second configuration, where the first sub-band is within an active bandwidth part of the UE. The operations of 1715 may be performed in accordance with examples as disclosed herein. In some examples, aspects of the operations of 1715 may be performed by an SSB measurement component 1035 as described with reference to FIG. 10.

At 1720, the method may include measuring, via one or more sub-bands of the SBG, one or more SSBs of the set of multiple SSBs in accordance with at least one of the first configuration, the second configuration, or a combination thereof. The operations of 1720 may be performed in accordance with examples as disclosed herein. In some examples, aspects of the operations of 1720 may be performed by an SSB measurement component 1035 as described with reference to FIG. 10.

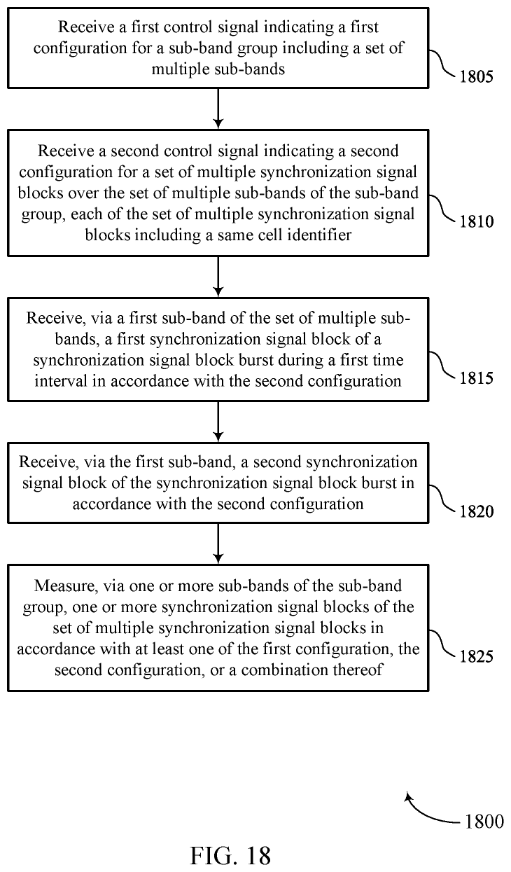

FIG. 18 shows a flowchart illustrating a method 1800 that supports SSB transmission for flexible spectrum integration in accordance with one or more aspects of the present disclosure. The operations of the method 1800 may be implemented by a UE or its components as described herein. For example, the operations of the method 1800 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1805, the method may include receiving a first control signal indicating a first configuration for a SBG including a set of multiple sub-bands. The operations of 1805 may be performed in accordance with examples as disclosed herein. In some examples, aspects of the operations of 1805 may be performed by an SBG configuration component 1025 as described with reference to FIG. 10.

At 1810, the method may include receiving a second control signal indicating a second configuration for a set of multiple SSBs over the set of multiple sub-bands of the SBG, each of the set of multiple SSBs including a same cell identifier. The operations of 1810 may be performed in accordance with examples as disclosed herein. In some examples, aspects of the operations of 1810 may be performed by an SSB measurement configuration component 1030 as described with reference to FIG. 10.

At 1815, the method may include receiving, via a first sub-band of the set of multiple sub-bands, a first SSB of an SSB burst during a first time interval in accordance with the second configuration. The operations of 1815 may be performed in accordance with examples as disclosed herein. In some examples, aspects of the operations of 1815 may be performed by an SSB measurement component 1035 as described with reference to FIG. 10.

At 1820, the method may include receiving, via the first sub-band, a second SSB of the SSB burst in accordance with the second configuration. The operations of 1820 may be performed in accordance with examples as disclosed herein. In some examples, aspects of the operations of 1820 may be performed by an SSB measurement component 1035 as described with reference to FIG. 10.

At 1825, the method may include measuring, via one or more sub-bands of the SBG, one or more SSBs of the set of multiple SSBs in accordance with at least one of the first configuration, the second configuration, or a combination thereof. The operations of 1825 may be performed in accordance with examples as disclosed herein. In some examples, aspects of the operations of 1825 may be performed by an SSB measurement component 1035 as described with reference to FIG. 10.

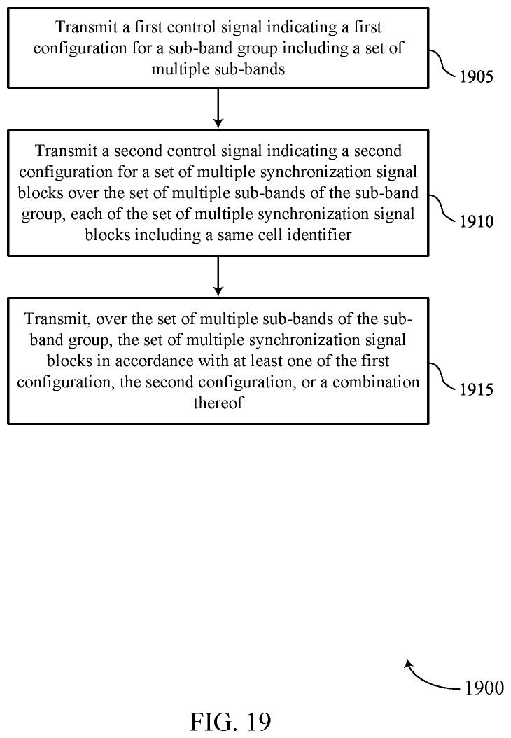

FIG. 19 shows a flowchart illustrating a method 1900 that supports SSB transmission for flexible spectrum integration in accordance with one or more aspects of the present disclosure. The operations of the method 1900 may be implemented by a network node or its components as described herein. For example, the operations of the method 1900 may be performed by a network node as described with reference to FIGS. 1 through 7 and 12 through 15. In some examples, a network node may execute a set of instructions to control the functional elements of the network node to perform the described functions. Additionally, or alternatively, the network node may perform aspects of the described functions using special-purpose hardware.

At 1905, the method may include transmitting a first control signal indicating a first configuration for a SBG including a set of multiple sub-bands. The operations of 1905 may be performed in accordance with examples as disclosed herein. In some examples, aspects of the operations of 1905 may be performed by an SBG configuration component 1425 as described with reference to FIG. 14.

At 1910, the method may include transmitting a second control signal indicating a second configuration for a set of multiple SSBs over the set of multiple sub-bands of the SBG, each of the set of multiple SSBs including a same cell identifier. The operations of 1910 may be performed in accordance with examples as disclosed herein. In some examples, aspects of the operations of 1910 may be performed by an SSB measurement configuration component 1430 as described with reference to FIG. 14.

At 1915, the method may include transmitting, over the set of multiple sub-bands of the SBG, the set of multiple SSBs in accordance with at least one of the first configuration, the second configuration, or a combination thereof. The operations of 1915 may be performed in accordance with examples as disclosed herein. In some examples, aspects of the operations of 1915 may be performed by an SSB transmission component 1435 as described with reference to FIG. 14.

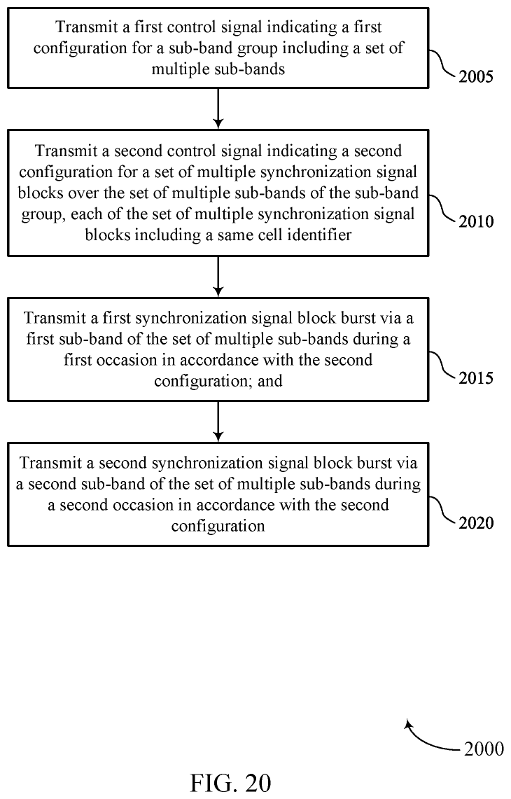

FIG. 20 shows a flowchart illustrating a method 2000 that supports SSB transmission for flexible spectrum integration in accordance with one or more aspects of the present disclosure. The operations of the method 2000 may be implemented by a network node or its components as described herein. For example, the operations of the method 2000 may be performed by a network node as described with reference to FIGS. 1 through 7 and 12 through 15. In some examples, a network node may execute a set of instructions to control the functional elements of the network node to perform the described functions. Additionally, or alternatively, the network node may perform aspects of the described functions using special-purpose hardware.

At 2005, the method may include transmitting a first control signal indicating a first configuration for a SBG including a set of multiple sub-bands. The operations of 2005 may be performed in accordance with examples as disclosed herein. In some examples, aspects of the operations of 2005 may be performed by an SBG configuration component 1425 as described with reference to FIG. 14.

At 2010, the method may include transmitting a second control signal indicating a second configuration for a set of multiple SSBs over the set of multiple sub-bands of the SBG, each of the set of multiple SSBs including a same cell identifier. The operations of 2010 may be performed in accordance with examples as disclosed herein. In some examples, aspects of the operations of 2010 may be performed by an SSB measurement configuration component 1430 as described with reference to FIG. 14.

At 2015, the method may include transmitting a first SSB burst via a first sub-band of the set of multiple sub-bands during a first occasion in accordance with the second configuration; and. The operations of 2015 may be performed in accordance with examples as disclosed herein. In some examples, aspects of the operations of 2015 may be performed by an SSB transmission component 1435 as described with reference to FIG. 14.

At 2020, the method may include transmitting a second SSB burst via a second sub-band of the set of multiple sub-bands during a second occasion in accordance with the second configuration. The operations of 2020 may be performed in accordance with examples as disclosed herein. In some examples, aspects of the operations of 2020 may be performed by an SSB transmission component 1435 as described with reference to FIG. 14.

The following provides an overview of aspects of the present disclosure:
Aspect 1: A method for wireless communications at a UE, comprising: receiving a first control signal indicating a first configuration for a sub-band group comprising a plurality of sub-bands; receiving a second control signal indicating a second configuration for a plurality of synchronization signal blocks over the plurality of sub-bands of the sub-band group, each of the plurality of synchronization signal blocks comprising a same cell identifier; and measuring, via one or more sub-bands of the sub-band group, one or more synchronization signal blocks of the plurality of synchronization signal blocks in accordance with at least one of the first configuration, the second configuration, or a combination thereof.
Aspect 2: The method of aspect 1, wherein the second control signal indicates a frequency hopping pattern for the plurality of synchronization signal blocks, a first synchronization signal block burst is associated with a first sub-band of the plurality of sub-bands during a first time interval, and a second synchronization signal block burst is associated with a second sub-band of the plurality of sub-bands during a second time interval in accordance with the frequency hopping pattern.
Aspect 3: The method of any of aspects 1 through 2, wherein measuring the one or more synchronization signal blocks comprises: receiving a first synchronization signal block burst via a first sub-band of the plurality of sub-bands in accordance with the second configuration, wherein the first sub-band is within an active bandwidth part of the UE.
Aspect 4: The method of aspect 3, further comprising: receiving a second synchronization signal block burst via a second sub-band of the plurality of sub-bands, wherein the second sub-band is within the active bandwidth part of the UE.
Aspect 5: The method of any of aspects 1 through 4, wherein a periodicity of a synchronization signal block burst associated with a sub-band of the sub-band group is based at least in part on a quantity of the plurality of sub-bands in the sub-band group.
Aspect 6: The method of any of aspects 1 through 5, wherein the second control signal indicates a beam sweeping pattern for the plurality of synchronization signal blocks across the plurality of sub-bands, a first synchronization signal block of a synchronization signal block burst is associated with a first sub-band of the plurality of sub-bands, and a second synchronization signal block of the synchronization signal block burst is associated with a second sub-band of the plurality of sub-bands.
Aspect 7: The method of aspect 6, wherein the second control signal indicates a first bitmap that maps at least the first synchronization signal block to the first sub-band and a second bitmap that maps at least the second synchronization signal block to the second sub-band.
Aspect 8: The method of any of aspects 6 through 7, wherein a quantity of synchronization signal blocks associated with the first sub-band is based at least in part on a bandwidth size of the first sub-band.
Aspect 9: The method of any of aspects 1 through 8, further comprising: receiving, via a first sub-band of the plurality of sub-bands, a first synchronization signal block of a synchronization signal block burst during a first time interval in accordance with the second configuration, wherein remaining synchronization blocks of the synchronization signal block burst are associated with different sub-bands of the plurality of sub-bands; and receiving, via the first sub-band, the first synchronization signal block during a second time interval in accordance with the second configuration.
Aspect 10: The method of any of aspects 1 through 9, wherein the second control signal indicates a cyclic beam sweeping pattern for the plurality of synchronization signal blocks across the plurality of sub-bands and a plurality of intervals.
Aspect 11: The method of any of aspects 1 through 10, wherein measuring the one or more synchronization signal blocks comprises: receiving, via a first sub-band of the plurality of sub-bands, a first synchronization signal block of a synchronization signal block burst during a first time interval in accordance with the second configuration; and receiving, via the first sub-band, a second synchronization signal block of the synchronization signal block burst in accordance with the second configuration.
Aspect 12: The method of any of aspects 1 through 11, further comprising: receiving an indication that synchronization signal blocks received via a first sub-band are quasi co-located with a data channel, a control channel, or a reference signal, or any combination thereof, on a second sub-band.
Aspect 13: The method of any of aspects 1 through 12, wherein the second control signal indicates one or more beam bitmaps, one or more transmit powers, one or more time offsets, or one or more periodicities, or any combination thereof, for the plurality of synchronization signal blocks.
Aspect 14: The method of any of aspects 1 through 13, wherein the second control signal indicates a first set of parameters for cell-defining synchronization signal blocks and a second set of parameters for non-cell defining synchronization signal blocks.
Aspect 15: The method of any of aspects 1 through 14, wherein a first sub-band of the plurality of sub-bands is associated with non-cell defining synchronization signal blocks, and a second sub-band of the plurality of sub-bands is associated with cell defining synchronization signal blocks.
Aspect 16: The method of any of aspects 1 through 15, wherein the one or more synchronization signal blocks comprise one or more cell defining synchronization signal blocks or one or more non-cell defining synchronization signal blocks, or both.
Aspect 17: The method of any of aspects 1 through 16, further comprising: transmitting a measurement report based at least in part on measuring the one or more synchronization signal blocks.
Aspect 18: A method for wireless communications at a network node, comprising: transmitting a first control signal indicating a first configuration for a sub-band group comprising a plurality of sub-bands; transmitting a second control signal indicating a second configuration for a plurality of synchronization signal blocks over the plurality of sub-bands of the sub-band group, each of the plurality of synchronization signal blocks comprising a same cell identifier; and transmitting, over the plurality of sub-bands of the sub-band group, the plurality of synchronization signal blocks in accordance with at least one of the first configuration, the second configuration, or a combination thereof.
Aspect 19: The method of aspect 18, wherein the second control signal indicates a frequency hopping pattern for the plurality of synchronization signal blocks, a first synchronization signal block burst is associated with a first sub-band of the plurality of sub-bands during a first time interval, and a second synchronization signal block burst is associated with a second sub-band of the plurality of sub-bands during a second time interval in accordance with the frequency hopping pattern.
Aspect 20: The method of any of aspects 18 through 19, wherein measuring the one or more synchronization signal blocks comprises: transmitting a first synchronization signal block burst via a first sub-band of the plurality of sub-bands during a first occasion in accordance with the second configuration; and transmitting a second synchronization signal block burst via a second sub-band of the plurality of sub-bands during a second occasion in accordance with the second configuration.
Aspect 21: The method of any of aspects 18 through 20, wherein a periodicity of a synchronization signal block burst associated with a sub-band of the sub-band group is based at least in part on a quantity of the plurality of sub-bands in the sub-band group.
Aspect 22: The method of any of aspects 18 through 21, wherein the second control signal indicates a beam sweeping pattern for the plurality of synchronization signal blocks across the plurality of sub-bands, a first synchronization signal block of a synchronization signal block burst is associated with a first sub-band of the plurality of sub-bands, and a second synchronization signal block of the synchronization signal block burst is associated with a second sub-band of the plurality of sub-bands.
Aspect 23: The method of aspect 22, wherein the second control signal indicates a first bitmap that maps at least the first synchronization signal block to the first sub-band and a second bitmap that maps at least the second synchronization signal block to the second sub-band.
Aspect 24: The method of any of aspects 22 through 23, wherein a quantity of synchronization signal blocks associated with the first sub-band is based at least in part on a bandwidth size of the first sub-band.
Aspect 25: The method of any of aspects 18 through 24, further comprising: transmitting, via a first sub-band of the plurality of sub-bands using a first beam, a first synchronization signal block of a synchronization signal block burst during a first time interval in accordance with the second configuration; and transmitting, via a second sub-band of the plurality of sub-bands using a second beam, a second synchronization signal block of the synchronization signal block burst during the first time interval in accordance with the second configuration.
Aspect 26: The method of aspect 25, further comprising: transmitting, via the first sub-band of the plurality of sub-bands using the first beam, a third synchronization signal block of a second synchronization signal block burst during a second time interval in accordance with the second configuration.
Aspect 27: The method of any of aspects 25 through 26, further comprising: transmitting, via the first sub-band of the plurality of sub-bands using the second beam, a third synchronization signal block of a second synchronization signal block burst during a second time interval in accordance with the second configuration.
Aspect 28: The method of any of aspects 18 through 27, wherein the second control signal indicates a cyclic beam sweeping pattern for the plurality of synchronization signal blocks across the plurality of sub-bands and a plurality of intervals.
Aspect 29: The method of any of aspects 18 through 28, further comprising: transmitting an indication that synchronization signal blocks transmitted via a first sub-band are quasi co-located with a data channel, a control channel, or a reference signal, or any combination thereof, on a second sub-band.
Aspect 30: The method of any of aspects 18 through 29, further comprising: receiving a measurement report based at least in part on one or more synchronization signal blocks of the plurality of synchronization signal blocks.
Aspect 31: A UE for wireless communications, comprising one or more memories storing processor-executable code, and one or more processors coupled with the one or more memories and individually or collectively operable to execute the code to cause the UE to perform a method of any of aspects 1 through 17.
Aspect 32: A UE for wireless communications, comprising at least one means for performing a method of any of aspects 1 through 17.
Aspect 33: A non-transitory computer-readable medium storing code for wireless communications, the code comprising instructions executable by one or more processors to perform a method of any of aspects 1 through 17.
Aspect 34: A network node for wireless communications, comprising one or more memories storing processor-executable code, and one or more processors coupled with the one or more memories and individually or collectively operable to execute the code to cause the network node to perform a method of any of aspects 18 through 30.
Aspect 35: A network node for wireless communications, comprising at least one means for performing a method of any of aspects 18 through 30.
Aspect 36: A non-transitory computer-readable medium storing code for wireless communications, the code comprising instructions executable by one or more processors to perform a method of any of aspects 18 through 30.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive a first control signal indicating a first configuration for a sub-band group comprising a plurality of sub-bands;
receive a second control signal indicating a second configuration for a plurality of synchronization signal blocks over the plurality of sub-bands of the sub-band group, each of the plurality of synchronization signal blocks comprising a same cell identifier; and
measure, via one or more sub-bands of the sub-band group, one or more synchronization signal blocks of the plurality of synchronization signal blocks in accordance with at least one of the first configuration, the second configuration, or a combination thereof.

2. The UE of claim 1, wherein the second control signal indicates a frequency hopping pattern for the plurality of synchronization signal blocks, and a first synchronization signal block burst is associated with a first sub-band of the plurality of sub-bands during a first time interval, and a second synchronization signal block burst is associated with a second sub-band of the plurality of sub-bands during a second time interval in accordance with the frequency hopping pattern.

3. The UE of claim 1, wherein, to measure the one or more synchronization signal blocks, the one or more processors are individually or collectively operable to execute the code to cause the UE to:
receive a first synchronization signal block burst via a first sub-band of the plurality of sub-bands in accordance with the second configuration, wherein the first sub-band is within an active bandwidth part of the UE.

4. The UE of claim 3, wherein the one or more processors are individually or collectively further operable to execute the code to cause the UE to:
receive a second synchronization signal block burst via a second sub-band of the plurality of sub-bands, wherein the second sub-band is within the active bandwidth part of the UE.

5. The UE of claim 1, wherein a periodicity of a synchronization signal block burst associated with a sub-band of the sub-band group is based at least in part on a quantity of the plurality of sub-bands in the sub-band group.

6. The UE of claim 1, wherein the second control signal indicates a beam sweeping pattern for the plurality of synchronization signal blocks across the plurality of sub-bands, a first synchronization signal block of a synchronization signal block burst is associated with a first sub-band of the plurality of sub-bands, and a second synchronization signal block of the synchronization signal block burst is associated with a second sub-band of the plurality of sub-bands.

7. The UE of claim 6, wherein the second control signal indicates a first bitmap that maps at least the first synchronization signal block to the first sub-band and a second bitmap that maps at least the second synchronization signal block to the second sub-band.

8. The UE of claim 6, wherein a quantity of synchronization signal blocks associated with the first sub-band is based at least in part on a bandwidth size of the first sub-band.

9. The UE of claim 1, wherein the one or more processors are individually or collectively further operable to execute the code to cause the UE to:
receive, via a first sub-band of the plurality of sub-bands, a first synchronization signal block of a synchronization signal block burst during a first time interval in accordance with the second configuration, wherein remaining synchronization signal blocks of the synchronization signal block burst are associated with different sub-bands of the plurality of sub-bands; and
receive, via the first sub-band, the first synchronization signal block during a second time interval in accordance with the second configuration.

10. The UE of claim 1, wherein the second control signal indicates a cyclic beam sweeping pattern for the plurality of synchronization signal blocks across the plurality of sub-bands and a plurality of intervals.

11. The UE of claim 1, wherein, to measure the one or more synchronization signal blocks, the one or more processors are individually or collectively operable to execute the code to cause the UE to:
receive, via a first sub-band of the plurality of sub-bands, a first synchronization signal block of a synchronization signal block burst during a first time interval in accordance with the second configuration; and
receive, via the first sub-band, a second synchronization signal block of the synchronization signal block burst in accordance with the second configuration.

12. The UE of claim 1, wherein the one or more processors are individually or collectively further operable to execute the code to cause the UE to:
receive an indication that synchronization signal blocks received via a first sub-band are quasi co-located with a data channel, a control channel, or a reference signal, or any combination thereof, on a second sub-band.

13. The UE of claim 1, wherein the second control signal indicates one or more beam bitmaps, one or more transmit powers, one or more time offsets, or one or more periodicities, or any combination thereof, for the plurality of synchronization signal blocks.

14. The UE of claim 1, wherein the second control signal indicates a first set of parameters for cell defining synchronization signal blocks and a second set of parameters for non-cell defining synchronization signal blocks.

15. The UE of claim 1, wherein a first sub-band of the plurality of sub-bands is associated with non-cell defining synchronization signal blocks, and a second sub-band of the plurality of sub-bands is associated with cell defining synchronization signal blocks.

16. The UE of claim 1, wherein the one or more synchronization signal blocks comprise one or more cell defining synchronization signal blocks or one or more non-cell defining synchronization signal blocks, or both.

17. The UE of claim 1, wherein the one or more processors are individually or collectively further operable to execute the code to cause the UE to:
transmit a measurement report based at least in part on measuring the one or more synchronization signal blocks.

18. A method for wireless communications at a user equipment (UE), comprising:
receiving a first control signal indicating a first configuration for a sub-band group comprising a plurality of sub-bands;
receiving a second control signal indicating a second configuration for a plurality of synchronization signal blocks over the plurality of sub-bands of the sub-band group, each of the plurality of synchronization signal blocks comprising a same cell identifier; and
measuring, via one or more sub-bands of the sub-band group, one or more synchronization signal blocks of the plurality of synchronization signal blocks in accordance with at least one of the first configuration, the second configuration, or a combination thereof.

19. The method of claim 18, wherein the second control signal indicates a frequency hopping pattern for the plurality of synchronization signal blocks, and a first synchronization signal block burst is associated with a first sub-band of the plurality of sub-bands during a first time interval, and a second synchronization signal block burst is associated with a second sub-band of the plurality of sub-bands during a second time interval in accordance with the frequency hopping pattern.

20. A user equipment (UE) for wireless communications, comprising:
means for receiving a first control signal indicating a first configuration for a sub-band group comprising a plurality of sub-bands;
means for receiving a second control signal indicating a second configuration for a plurality of synchronization signal blocks over the plurality of sub-bands of the sub-band group, each of the plurality of synchronization signal blocks comprising a same cell identifier; and
means for measuring, via one or more sub-bands of the sub-band group, one or more synchronization signal blocks of the plurality of synchronization signal blocks in accordance with at least one of the first configuration, the second configuration, or a combination thereof.
